(19) United States
(12) Patent Application Publication
(10) Pub. No.: US 2023/0105185 A1
(43) Pub. Date: Apr. 6, 2023

(54) COMPUTING SYSTEM FOR OVER TIME ANALYTICS USING GRAPH INTELLIGENCE

(71) Applicant: Microsoft Technology Licensing, LLC, Redmond, WA (US)

(72) Inventors: Vipindeep VANGALA, Hyderabad (IN); Mihir Uday MISTRY, Thane (IN)

(21) Appl. No.: 17/494,206

(22) Filed: Oct. 5, 2021

(51) Int. Cl. G06Q 10/10; G06F 16/9035; G06F 16/9038; G06F 16/901; G06N 20/00

(52) U.S. Cl. CPC G06Q 10/109; G06F 16/9035; G06F 16/9038; G06F 16/9024; G06N 20/00

(57) ABSTRACT

A computing system identifies a first subgraph and a second subgraph of a user graph of a user. The first subgraph represents first activities performed by the user in a plurality of applications during a first time period and the second subgraph represents second activities performed by the user in the plurality of applications during a second time period. The computing system identifies a topic of interest to the user based upon the first subgraph and the second subgraph. The computing system predicts an amount of time that the user will spend on working on the topic during a future time period based upon the first subgraph and the second subgraph, where the future time period occurs after the first time period and the second time period. The computing system causes an identifier for the topic and an indication of the amount of time to be displayed to the user.

### BACKGROUND

Computer-executable applications that help users to manage their time are important in maximizing productivity. However, conventional time tracking applications have limited functionality. With more specificity, conventional time tracking applications track time spent by a user within an individual application (e.g., time spent in an email application drafting emails, time spent in meetings in a meeting application, etc.) or an overall time the user spends utilizing a computing device (e.g., time spent logged in to the computing device). Thus, conventional time tracking applications have limited usefulness, especially in enterprise settings.

### SUMMARY

The following is a brief summary of subject matter that is described in greater detail herein. This summary is not intended to be limiting as to the scope of the claims.

Described herein are various technologies that facilitate over time analytics using graph intelligence. For example, a user graph of a user includes nodes and edges connecting the nodes, where the nodes and the edges represent activities performed by the user in a plurality of applications. The technologies described herein generate “snapshot graphs” of the user graph at different points in time, where a snapshot graph of the user graph is a subgraph of the user graph that represents activities performed by the user within a time period (e.g., activities performed by the user in a one week period). The technologies described herein utilize the snapshot graphs to provide an analytics view to a user that informs the user of topics (e.g., work areas) that the user has been working on in the past, as well as relative amounts of time that the user has spent working on the topics. The technologies described herein also identify behavioral patterns of the user over time, where the behavioral patterns may be utilized in providing rankings and recommendations to the user. Additionally, the technologies described herein utilize the snapshot graphs to predict behaviors of the user in the future and provide recommended behavior changes to the user based upon the predicted behaviors.

In example operation, a computing system accesses a user graph of a user. The user graph includes nodes and edges connecting the nodes, where the nodes represent entities (e.g., documents, people, emails, tasks, meetings, etc.) associated with the user and where the edges represents relationships (e.g., read a document, drafted an email, etc.) between the entities represented by the nodes. In an example, a first node in the user graph representing the user is connected to a second node in the user graph representing a document via an edge, where the edge includes a label indicating that the user modified the document. Thus, the nodes and the edges of the user graph represent activities performed by the user in a plurality of applications (e.g., an email application, a word processing application, etc.).

The user graph includes timestamps (e.g., dates and times on the dates) that correspond to performance of the activities by the user. In an example, the edges of the user graph include the timestamps. Following the example above, the edge connecting the first node to the second node includes a timestamp that indicates when the user modified the document. The timestamp may include a first timestamp indicating when the user began to modify the document and a second timestamp indicating when the user finished modifying the document. In an example, the computing system identifies a first subset of edges in the user graph that include timestamps that fall within a first time period (e.g., the past week). The computing system extracts the first subset of edges and a first subset of nodes in the user graph that are connected to the first subset of edges to generate a first subgraph (e.g., a first snapshot graph) of the user graph. The computing system identifies a second subset of edges in the user graph that have timestamps that fall within a second time period (e.g., the week prior to the past week). The computing system extracts the second subset of edges and a second subset of nodes in the user graph that are connected to the second subset of edges to generate a second subgraph (e.g., a second snapshot graph) of the user graph. Thus, the first subgraph represents first activities performed by the user in the plurality of applications during the first time period and the second subgraph represents second activities performed by the user in the plurality of applications during the second time period.

The computing system identifies, via a machine learning (ML) engine, one or more topics of interest (e.g., work areas) of the user based upon first data (e.g., first nodes and first edges) included in the first subgraph and second data (e.g., second nodes and second edges) included in the second subgraph. The computing system also identifies, via the ML engine and based upon the first data included in the first subgraph and the second data included in the second subgraph, entities (e.g., documents, people, emails, tasks, meetings, etc.) associated with each of the one or more topics of interest during each of the first time period and the second time period. The computing system determines amounts of time spent by the user working on the one or more topics of interest during each of the first time period and the second time period based upon the first data included in the first subgraph and the second data included in the second subgraph. The computing system also determines, via the ML engine and based upon the first data and the second data, amounts of time that the user is predicted to spend working on each the one or more topics of interest during a future time period (e.g., the next week) that is to occur subsequent to the first time period and the second time period. The computing system may also generate, via the ML engine, recommendations for how the user should focus his/her efforts during the future time period with respect to the one or more topics based upon suitable criteria, such as a role of the user within an organization, the predicted amounts of time, and/or the entities associated with each of the one or more topics. The computing system causes an analytics view to be presented on a display to the user, where the analytics view includes one or more of identifiers for the topic(s) of interest during each of the first time period and the second time period, identifiers for entities associated with the topic(s) of interest during each of the first time period and the second time period, indications of amounts of time spent by the user working on the topic(s) of interest during each of the first time period and the second time period, indications of the amounts of time that the user is predicted to spend working on the topic(s) of interest during the future time period, and/or the recommendations for the user to follow during the future time period (collectively referred to as “the user analytics data”). The computing system may also use the user analytics data in ranking search results obtained from searches of the user graph.

The above described technologies present various advantages over conventional time tracking applications. First, vis-à-vis the generation of subgraphs of the user graph which each represent activities performed by the user during different time periods, the above-described technologies are able to provide useful (over time) analytics data to a user that the user may utilize to adjust his/her behavior. Second, by identifying topics of interest of the user using the subgraphs and by identifying time spent by the user on the topics of interest using the subgraphs, the above-described technologies present the user with a more complete view of how his/her efforts are actually being spent over time. In contrast, conventional time tracking applications determine amounts of time spent by the user in different applications, but do not provide indications of the topics that the user was working on in the different applications. Third, the user analytics data may be utilized by search services as ranking criteria for search results, thus leading to more relevant search results being surfaced to the user. In an example, if the analytics data indicates that the user is predicted to spend a relatively large amount of time working on a topic during a current week, a search service may prioritize search results that relate to the topic.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an example computing environment that facilitates over time analytics using graph intelligence.

FIG. 2 illustrates an example high level overview of using graph intelligence to generate over time analytics.

FIG. 3A depicts an example user graph at a first point in time.

FIG. 3B depicts an example snapshot graph generated from the user graph depicted in FIG. 3A.

FIG. 4A depicts the example user graph in FIG. 3A at a second point in time.

FIG. 4B depicts an example snapshot graph generated from the user graph depicted in FIG. 4A.

FIG. 5 depicts an example graphical user interface (GUI) that presents over time analytics to a user.

FIG. 6 depicts another example GUI that presents over time analytics to a user.

FIG. 7A depicts an example GUI that presents topics of interest during a time period to a user.

FIG. 7B depicts an example detailed view of the GUI depicted in FIG. 7A.

FIG. 7C depicts an example GUI that presents topics of interest during a second time period to a user.

FIG. 8 is a flow diagram that illustrates an example methodology performed by a computing system that facilitates over time analytics using graph intelligence.

FIG. 9 depicts an example computing device.

Various technologies pertaining to over time analytics using graph intelligence are now described with reference to the drawings, where like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

### DETAILED DESCRIPTION

As noted above, conventional time tracking applications track time on a per-application basis and hence have limited usefulness, such as in enterprise settings where tracking personal productivity and identifying potential improvements is important. To address these issues, a computing system is described herein that is configured to generate “snapshot” graphs (also referred to herein as subgraphs) of a user graph of a user, where different snapshot graphs represent activities performed by the user in a plurality of applications during different time periods. The computing system, via a machine learning (ML) engine, generates predictions and/or recommendations for the user based upon data included in the snapshot graphs and presents the predictions and/or recommendations to the user. In an example, the computing system identifies a topic that has been of interest to the user during prior time periods based upon the snapshot graphs, determines amounts of time that the user has spent working on the topic during the prior time periods based upon the data included in the snapshot graphs, and generates a recommendation for the user as to how he/she should spend future efforts working on the topic during a future time period. The computing system may present a summary of trends of amounts of effort or time a user spent on a topic of interest (or an entity associated with a topic of interest) over past time periods.

In example operation, a computing system accesses a user graph of a user. The user graph includes nodes and edges connecting the nodes, where the nodes represent entities (e.g., documents, people, emails, tasks, meetings, etc.) associated with the user and where the edges represents relationships (e.g., created a document, attended a meeting, etc.) between the entities. In an example, a first node in the user graph representing the user is connected to a second node in the user graph representing a document via an edge, where the edge includes a label indicating that the user created the document. Thus, the nodes and the edges of the user graph represent activities performed by the user in a plurality of applications (e.g., an email application, a spreadsheet application, etc.).

The user graph includes timestamps (e.g., dates and times on the dates) that correspond to performance of the activities. In an example, the edges of the user graph include the timestamps. Following the example above, the edge connecting the first node to the second node includes a timestamp that indicates when the user created the document. The timestamp may include a first timestamp indicating when the user began to create the document and a second timestamp indicating when the user finished creating the document. In an example, the computing system identifies a first subset of edges in the user graph that include timestamps that fall within a first time period (e.g., the past month). The computing system extracts the first subset of edges and a first subset of nodes in the user graph that are connected to the first subset of edges to generate a first subgraph of the user graph. The computing system identifies a second subset of edges in the user graph that have timestamps that fall within a second time period (e.g., the month prior to the past month). The computing system extracts the second subset of edges and a second subset of nodes in the user graph that are connected to the second subset of edges to generate a second subgraph of the user graph. Thus, the first subgraph represents first activities performed by the user in the plurality of applications during the first time period and the second subgraph represents second activities performed by the user in the plurality of applications during the second time period.

The computing system identifies, via a machine learning (ML) engine, one or more topics of interest (e.g., work areas) of the user based upon first data (e.g., first nodes and first edges) included in the first subgraph and second data (e.g., second nodes and second edges) included in the second subgraph. The computing system also identifies, via the ML engine and based upon the first data included in the first subgraph and the second data included in the second subgraph, entities (e.g., documents, people, emails, tasks, meetings, etc.) associated with each of the one or more topics of interest during each of the first time period and the second time period. The computing system determines amounts of time spent by the user working on the one or more topics of interest during each of the first time period and the second time period based upon the first data included in the first subgraph and the second data included in the second subgraph. The computing system may also determine particular types of activities performed by the user with respect to each of the topics during each of the time periods (e.g., an amount of time spent by the user drafting emails pertaining to the topic during the first time period, an amount of time spent by the user attending meetings pertaining to the topic during the first time period, etc.). The computing system also determines, via the ML engine and based upon the first data and the second data, amounts of time that the user is predicted to spend working on each of the one or more topics of interest during a future time period (e.g., the next month) that occurs subsequent to the first time period and the second time period. The computing system may also generate, via the ML engine, recommendations for how the user should focus his/her efforts during the future time period with respect to the one or more topics based upon suitable criteria, such as a role of the user within an organization, the predicted amounts of time, and/or the entities associated with the one or more topics. The computing system causes an analytics view to be presented on a display to the user, where the analytics view includes one or more of identifiers for the topic(s) of interest during each of the first time period and the second time period, identifiers for entities associated with the topics of interest during each of the first time period and the second time period, indications of amounts of time spent by the user working on the topic(s) of interest during each of the first time period and the second time period, indications of the predicted amounts of time the user is predicted to spend working on each the topic(s) of interest during the future time period, and/or the recommendations for the user to follow during the future time period (collectively referred to as “the user analytics data”). The computing system may also use the user analytics data in ranking search results obtained from searches of the user graph.

The above described technologies present various advantages over conventional time tracking applications. First, vis-à-vis the generation of subgraphs of the user graph which each represent activities performed by the user during different time periods, the above-described technologies are able to provide useful (over time) analytics data to a user that the user may utilize to adjust his/her behavior. Second, by identifying topics of interest of the user using the subgraphs and by identifying time spent by the user on the topics of interest using the subgraphs, the above-described technologies present the user with a more complete view of how his/her efforts are actually being spent over time. In contrast, conventional time tracking applications determine amounts of time spent by the user in different applications, but do not provide indications of the topics that the user was working on in the different applications. Third, the user analytics data may be utilized by search services as ranking criteria for search results, thus leading to more relevant search results being surfaced to the user. In an example, if the analytics data indicates that the user is predicted to spend a relatively large amount of time working on a topic during a current week, a search service may prioritize search results that relate to the topic.

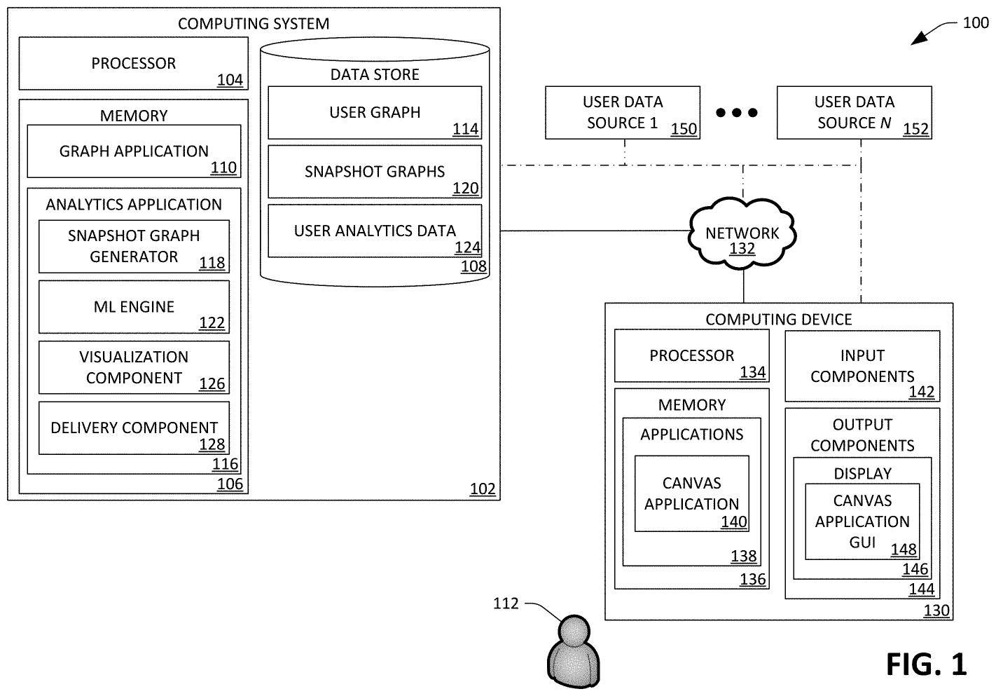

With reference to FIG. 1, an example computing environment 100 that facilitates over time analytics using graph intelligence is illustrated. The computing environment 100 includes a computing system 102. According to embodiments, the computing system 102 is a cloud-based computing platform. According to other embodiments, the computing system 102 is a server computing device. The computing system 102 includes a processor 104, memory 106, and a data store 108.

The memory 106 includes a graph application 110. As will be explained in greater detail below, the graph application 110, when executed by the processor 104, is configured to (1) obtain (e.g., receive or generate) user activity data of a user 112 from a plurality of applications utilized by the user 112 and (2) generate and maintain a user graph 114 for the user 112 based upon the user activity data, where the user graph 114 is stored in the data store 108. The graph application 110 is also configured to execute searches over the user graph 114 based upon search queries received from users. The user activity data may include historical activity data and/or real-time data collected via a plugin or interop communication. According to embodiments, the plurality of application include Microsoft® Word, Microsoft® Excel, Microsoft® PowerPoint®, Microsoft® Outlook®, Microsoft Teams®, Microsoft Edge®, and/or Microsoft® SharePoint®.

The user graph 114 for the user 112 comprises nodes and edges connecting the nodes. The nodes represent entities associated with the user 112 and the edges represent relationships between the entities. As such, a first node connected to a second node by an edge in the user graph 114 may represent an activity performed by the user 112 in one of the plurality of applications. Additionally, a first node connected to a second node by an edge in the user graph 114 may represent an event that has occurred that relates to the user 112. An entity may be a person (e.g., another user), a document of the user 112 (e.g., a document created by, modified by, or viewed by the user 112), an email of the user 112 (e.g., an email read by or sent by the user 112), a meeting (e.g., electronic meetings, in-person meetings, etc.) that the user 112 has attended or is scheduled to attend, a task the user 112 has completed or has agreed to complete, a topic of interest to the user 112 (e.g., a work area of the user 112), a computer-executable application used by the user 112, a location associated with the user 112, a real-time message sent by the user 112 or received by the user 112 via a real-time messaging application, and/or a key phrase associated with a topic of interest to the user 112. The entity may be an activity of the user. Documents of the user 112 may include word processing document, spreadsheets, and/or slideshows. Example relationships represented by the edges in the user graph 114 may include created by, modified by, read by, communicated with, managed by, manages, assigned, and/or attended.

In a first example, the graph application 110 receives a first indication that the user 112 has created a document using an application in the plurality of applications. The graph application 110 generates a first node in the user graph 114 that represents the document that the user 112 has created and connects the first node to a second node in the user graph 114 that represents the user 112. The graph application 110 connects the first node to the second node via a first edge and assigns a first label to the first edge indicating that the user 112 created the document represented by the first node. In a second example, the graph application 110 receives a second indication that the user 112 has been assigned a task. The graph application 110 generates a third node in the user graph 114 that represents the task that the user 112 has been assigned. The graph application 110 connects the third node to the second node via a second edge and assigns a second label to the second edge indicating that the user 112 has been assigned the task represented by the third node.

When the graph application 110 adds a node and/or an edge to the user graph 114, the graph application 110 assigns a timestamp (e.g., a date and a time on the date) to the node and/or the edge, where the timestamp is indicative of when the user 112 performed an activity in one of the plurality of applications or when an event occurred that is associated with the user 112. As such, it is to be understood that the nodes and/or the edges in the user graph 114 include timestamps.

Following the first example given above, the graph application 110 causes a first timestamp corresponding to when the document was created to be included in the first edge connecting the first node to the second node. The first timestamp may include more than one timestamp, such as a timestamp corresponding to when the user 112 began to create the document and a timestamp corresponding to when the user 112 finished creating the document. Following the second example given above, the graph application 110 causes a second timestamp corresponding to when the user 112 was assigned the task to be included in the second edge connecting the second node to the third node.

Nodes in the user graph 114 may include metadata. Nodes that represent entities such as documents, emails, and real-time messages may include metadata that includes identifiers for storage locations of the documents, the emails, and the real-time messages. The metadata may also include identifiers for entities that the nodes represent, timestamps, etc. According to embodiments, an identifier for a storage location is expressed as a uniform resource identifier (URI) or a uniform resource locator (URL). In an example, the graph application 110 receives an identifier for a storage location of a word processing document when the word processing document is created by the user 112 via an application in the plurality of applications. The graph application 110 causes the identifier for the storage location of the word processing document to be included in metadata of a node representing the word processing document. The graph application 110 (or another application) may access the word processing document using the identifier for the storage location included in the metadata for the node.

Although the data store 108 has been described above as storing a (single) user graph for the user 112, it is to be understood that the data store 108 may store many different user graphs, where each user graph is assigned to a different user.

The memory 106 further includes an analytics application 116. As will be explained in greater detail below, the analytics application 116, when executed by the processor 104, is generally configured to generate over time analytics for the user 112 (as well as other users) using graph intelligence.

The analytics application 116 includes a snapshot graph generator 118. The snapshot graph generator 118 is configured to generate snapshot graphs 120 (also referred to herein as subgraphs) of the user graph 114, where each of the snapshot graphs 120 represents activities performed by the user 112 in a plurality of applications during a particular time period. In an example, the snapshot graphs 120 include a first snapshot graph of the user graph 114 that has first nodes and first edges representing first activities performed by the user 112 in the plurality of applications during a first time period and a second snapshot graph of the user graph 114 that includes second nodes and second edges representing second activities performed by the user 112 in the plurality of applications during a second time period. Time periods may include daily time periods, weekly time periods, monthly time periods, or custom periods. Following the previous example, the first time period may be a first week that occurred immediately prior to a current date and the second time period may be a second week that occurred immediately prior to the first week. Stated differently, the first time period and the second time period may be consecutive, non-overlapping periods of time.

The analytics application 116 includes a machine learning (ML) engine 122 that is configured to perform processing on the snapshot graphs 120 (explained in greater detail below), where the processing results in user analytics data 124 being generated for the user 112. The ML engine 122 includes a plurality of computer-implemented models. The plurality of computer-implemented models may include page rank models, Hyperlink-Induced Topic Search (HITS) models, behavior modeling models, topic identification models, predictive models, and/or ranking models. The plurality of computer-implemented models include regression models or classifier models.

The data store 108 may store the user analytics data 124 of the user 112 that is generated by the analytics application 116. In an example, the analytics application 116 generates the user analytics data 124 offline and stores the user analytics data 124 in the data store 108. As will be described in greater detail below, the user analytics data 124 includes one or more of identifiers for topic(s) of interest of the user 112 during different time periods, identifiers for entities associated with the topic(s) of interest of the user 112 during the different time periods, indications of amounts of time spent by the user 112 working on the topic(s) of interest during each of the different time periods, indications of amounts of time spent by the user 112 working on particular types of activities within each of the topic(s) of interest during each of the different time periods, indications of predicted amounts of time that the user 112 is predicted to spend working on each of the topic(s) of interest during future time periods, indications of predicted amounts of time that the user 112 is predicted to spend working on particular types of activities within each of the topic(s) of interest during the future time periods, and/or recommendations as to how the user 112 should spend his/her time working on the topic(s) of interest during the future time periods. The user analytics data 124 may also include, for each time period, identifiers for people with whom the user 112 has had increased interaction with compared to prior time periods. The recommendations may include suggestions for people (e.g., users) with whom the user 112 should communicate with during the future time periods, identifiers for users that the user 112 should delegate certain tasks to with respect to a particular topic, suggested amounts of time that the user 112 should spend working on the topic(s) of interest during the future time periods, and/or suggested amounts of time that the user 112 should spend working on particular types of activities within the topic(s) of interest during the future time periods. According to embodiments, the ML engine 122 generates the user analytics data 124 in real-time upon receiving a request from the user 112.

The analytics application 116 further includes a visualization component 126 that is configured to generate visualizations based upon data from the snapshot graphs 120 and/or the user analytics data 124.

The analytics application 116 further includes a delivery component 128. The delivery component 128 is generally configured to deliver the user analytics data 124 to computing devices of users. The delivery component 128 may also deliver the user analytics data 124 to the graph application 110, where the graph application 110 may utilize the user analytics data 124 to rank search results obtained from searches executed over the user graph 114. According to embodiments, the delivery component 128 may provide the user analytics data 124 to a search service (not depicted in FIG. 1), where the search service utilizes the user analytics data 124 to rank search results (e.g., web search results).

The computing environment 100 further includes a computing device 130 that is operated by the user 112. In an example, the computing device 130 is a desktop computing device, a laptop computing device, a tablet computing device, a smartphone, or a wearable computing device. The computing device 130 is in communication with the computing system 102 by way of a network 132 (e.g., the Internet, intranet, etc.). The computing device 130 includes a processor 134 and memory 136, where the memory 136 includes a plurality of applications 138. The plurality of applications 138 may include a word processing application, a spreadsheet application, a slideshow application, a web browser, a real-time meeting application, a real-time messaging application, an email application, and/or a file navigation application. According to embodiments, the plurality of application 138 include Microsoft® Word, Microsoft® Excel, Microsoft® PowerPoint®, Microsoft® Outlook®, Microsoft Teams®, Microsoft Edge®, and/or Microsoft® SharePoint®. The nodes and edges of the user graph 114 are based partly or entirely upon activity history of the user in the plurality of applications 138. A canvas application 140 is included in the plurality of applications 138. The canvas application 140 is generally configured to present the user analytics data 124 to the user 112 (described in greater detail below) in the form of visualizations (e.g., visualizations generated by the visualization component 126).

The computing device 130 includes input components 142 that enable the user 112 to set forth input to the computing device 130. The input components 142 may include a mouse, a keyboard, a touchpad, a scroll wheel, a touchscreen, a microphone, a camera, and/or a video camera. The computing device 130 also includes output components 144 that enable the computing device 130 to output information to the user 112. The output components 144 include a display 146. The canvas application 140 presents a GUI 148 (also referred to herein as “the canvas application GUI 148”) on the display 146, where the GUI 148 includes graphical features (e.g., visualizations) related to the user analytics data 124. The output components 144 may also include a speaker (not illustrated in FIG. 1) that is configured to output audible sounds.

The computing environment 100 also includes a first user data source 150 and an Nth user data source 152, where N is a positive integer greater than one (collectively referred to herein as “the plurality of user data sources 150-152”). The plurality of user data sources 150-152 store data of the user 112. In an example, the first user data source 150 stores a text document authored by the user 112 and the Nth user data source 152 stores an email sent by the user 112 to another user. Nodes in the user graph 114 represent data (e.g., documents) stored in the plurality of user data sources 150-152. In an example, a node in the user graph 114 representing a spreadsheet of the user 112 stored in the first user data source 150 includes an identifier for a location of the spreadsheet within the first user data source 150. The graph application 110 and/or the analytics application 116 may access the spreadsheet of the user 112 using the identifier for the location of the spreadsheet within the first user data source 150. According to embodiments, the plurality of user data sources 150-152 are or include cloud-based storage, server-based storage, and/or local storage of devices operated by the user 112 (e.g., local storage of the computing device 130).

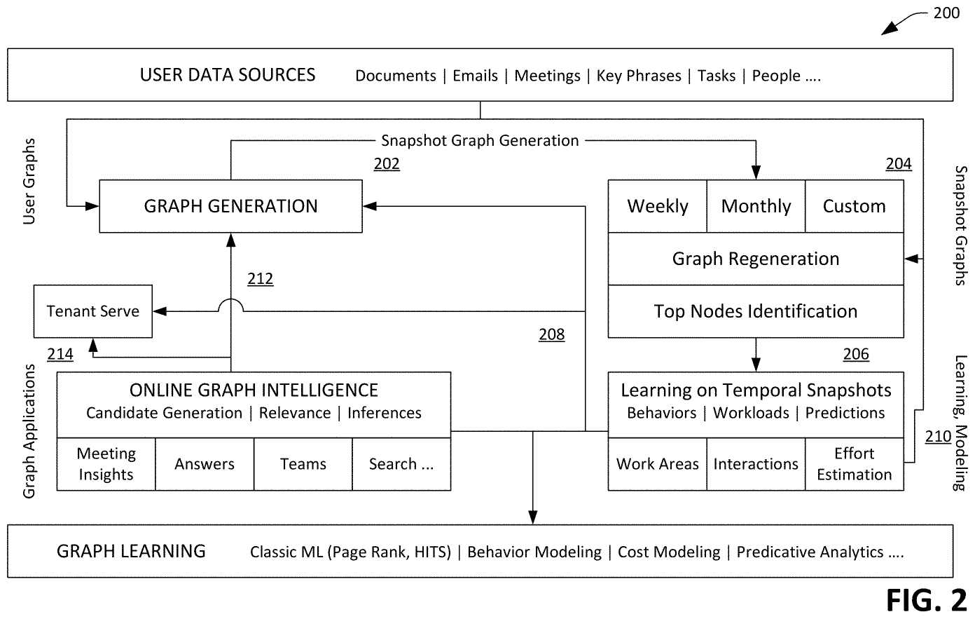

Referring now to FIG. 2, a high-level overview of an example process 200 of performing over time analytics is illustrated. The process 200 is performed by the computing system 102. At 202, the computing system 102 generates the user graph 114 for the user 112 based upon the user activity data of the user 112 in the plurality of applications. In an example, the computing system 102 generates the user graph 114 based upon data retained in user data sources (e.g., the plurality of user data sources 150-152), such as documents, emails, meetings (as stored in electronic calendars of the user 112), key phrases derived from the user activity data of the user 112, tasks the user 112 is to complete, identifiers for people with whom the user 112 communicates, etc.

At 204, the computing system 102 generates the snapshot graphs 120 based upon the user graph 114. Each snapshot graph is a subgraph of the user graph 114. Each snapshot graph represents activities of the user 112 performed in a plurality of applications during a different time period. The computing system 102 generates the snapshot graphs 120 by extracting nodes and edges from the user graph 114 that are associated with timestamps falling within a particular time period. In one example, each snapshot graph represents activities performed by the user 112 during different (consecutive) weeks. In another example, each snapshot graph represents activities performed by the user 112 during different (consecutive) months. The computing system 102 may also utilize custom time periods (e.g.,. bi-weekly, bi-monthly, etc.) to generate the snapshot graphs 120. According to embodiments, the snapshot graphs 120 include graphs that are dated from a six month period occurring prior to a current date, such as six monthly snapshot graphs or twenty-four weekly snapshot graphs. After initial generation of the snapshot graphs 120, it is contemplated that the computing system 102 continues to generate additional snapshot graphs at predefined intervals (e.g., once a week, once a month, etc.) and that the computing system 102 adds the additional snapshot graphs to the snapshot graphs 120 at the predefined intervals. The computing system 102 identifies “top” nodes in the snapshot graphs 120 using suitable criteria, such as page rank, HITS, etc. The computing system 102 determines topics of interest of the user 112 during the different time periods using the “top” nodes.

At 206, the computing system 102 generates the user analytics data 124 based upon the snapshot graphs 120. For example, the computing system 102 learns behaviors and workloads of the user 112 based upon the snapshot graphs 120.

At 208, the computing system 102 provides the user analytics data 124 to tenants (e.g., the computing device 130 of the user 112), where the user analytics data 124 is presented to the tenants. The computing system 102 may also utilize the user analytics data 124 to modify and/or supplement the user graph 114. The computing system 102 may also provide the user analytics data 124 to the graph application 110, where the graph application 110 may utilize the user analytics data 124 for graph searching purposes.

At 210, the computing system 102 utilizes the user analytics data 124 to modify and/or supplement the snapshot graphs 120. In an example, the computing system 102 causes identifiers for the entities of interest associated with each topic during the time periods and/or amounts of time the user 112 spent working on each of the topics during each of the time periods to be included in respective snapshot graphs. By incorporating the user analytics data 124 into the snapshot graphs 120, the computing system 102 does not need to recompute certain elements of the user analytics data 124 that does not change over time (e.g., the amount of time the user 112 has spent working on a topic in the past will not change, as the past has already occurred).

At 212, the computing system 102 may incorporate some or all of the user analytics data 124 into the user graph 114. In an example, the computing system 102 modifies nodes and edges within the user graph 114 based upon the user analytics data 124.

At 214, the computing system 102 may utilize the user analytics data 124 to enhance searches over the user graph 114. In an example, the user analytics 126 data is utilized as ranking criteria in ranking searches results obtained from searches of the user graph 114. The computing system 102 may also utilize the user analytics data 126 to provide answers to user questions, provide meeting insights (e.g., proactively provide identifiers for documents that are relevant to a meeting to the user 112 before the meeting has occurred), generate inferences about the user 112, etc.

With reference now to FIG. 1, example operation of the computing environment 100 is now set forth. The analytics application 116 obtains an indication of a time interval that is to be used in generating the snapshot graphs 120. In an example, the time interval is weekly and as such each of the snapshot graphs 120 represents a different, consecutive week. In another example, the time interval is monthly and as such each of the snapshot graphs 120 represents a different, consecutive month. The analytics application 116 accesses the user graph 114 from the data store 108.

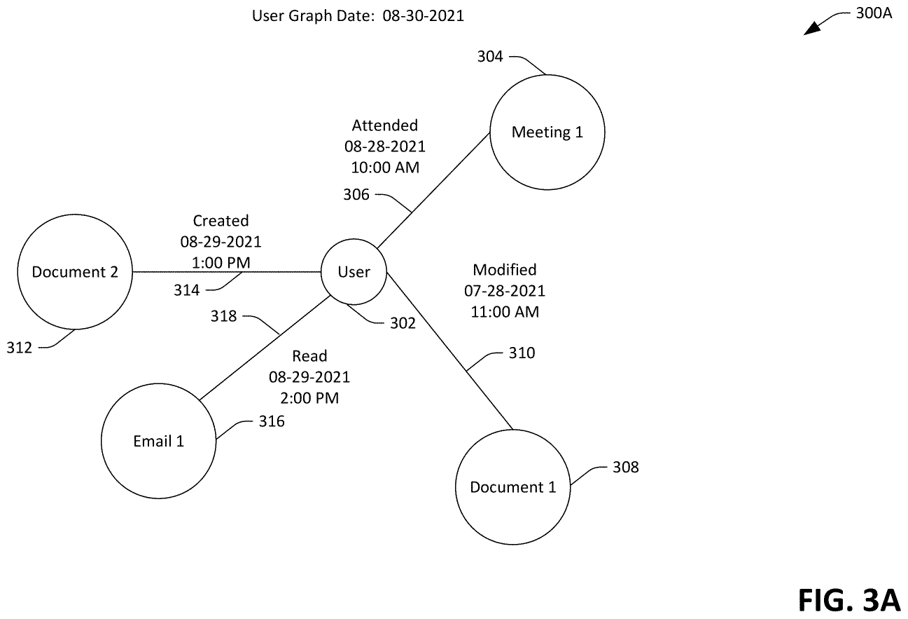

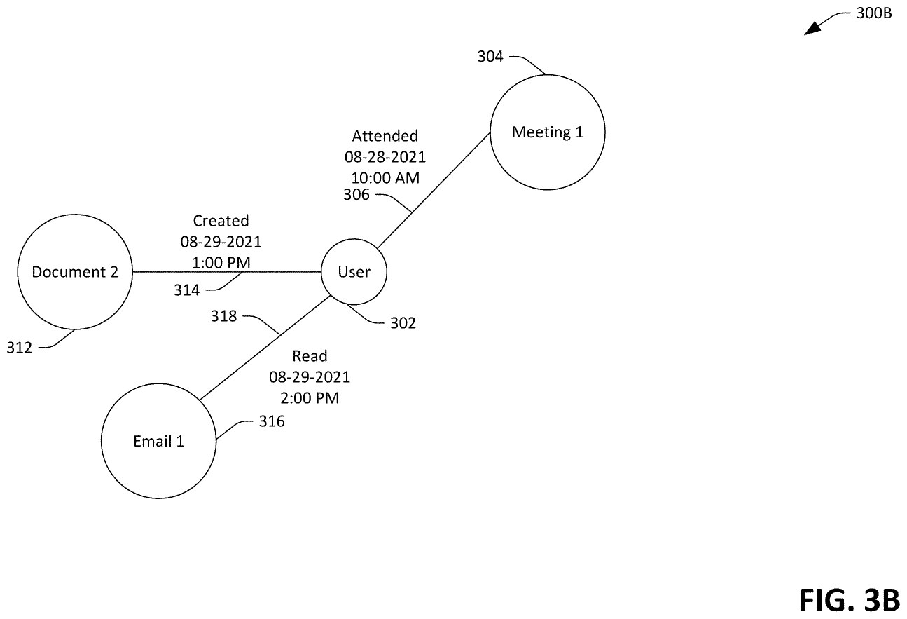

Turning now to FIG. 3A, an example user graph 300A at a first date (Aug. 30, 2021) is depicted. The user graph 300A may be or include the user graph 114 or the user graph 114 may be or include the user graph 300A. In the example depicted in FIG. 3A, the user graph 300A includes nodes and edges that represent activities performed by the user 112 on and before Aug. 30, 2021. The user graph 300A includes a first node 302 that represents the user 112 and a second node 304 that represents a first meeting. The first node 302 is connected to the second node 304 via a first edge 306, where the first edge 306 includes a label indicating a relationship (attended) and a first timestamp (Aug. 28, 2021 10:00 AM) indicating that the user 112 attended the first meeting at the date and time indicated by the first timestamp. The user graph 300A includes a third node 308 that represents a first document. The first node 302 is connected to the third node 308 via a second edge 310, where the second edge 310 includes a label indicating a relationship (modified) and a second timestamp (Jul. 28, 2021 11:00 AM) indicating that the user 112 modified the first document at the date and time indicated by the second timestamp. The user graph 300A includes a fourth node 312 that represents a second document. The first node 302 is connected to the fourth node 312 via a third edge 314, where the third edge 314 includes a label indicating a relationship (created) and a third timestamp (Aug. 29, 2021 1:00 PM) indicating that the second document was created by the user 112 at the date and time indicated by the third timestamp. The user graph 300A includes a fifth node 316 that represents a first email. The first node 302 is connected to the fifth node 316 via a fourth edge 318, where the fourth edge 318 includes a label indicating a relationship (read) and a fourth timestamp (Aug. 29, 2021 2:00 PM) indicating that the first email was read by the user 112 at the date and time indicated by the fourth timestamp.

Referring back to FIG. 1, the snapshot graph generator 118 of the analytics application 116 selects a first subset of edges of the user graph 114, where the first subset of edges have corresponding timestamps that fall within a first time period. In an example, the first time period is a seven day period that immediately precedes the current date (Aug. 30, 2021). The snapshot graph generator 118 generates a first snapshot graph (also referred to as a first subgraph) of the user graph 114 based upon the first subset of edges. The first snapshot includes a first subset of nodes of the user graph 114, where the first subset of nodes are connected via the first subset of edges. The first snapshot graph represents first activities performed by the user 112 in the plurality of applications during the first time period. The snapshot graph generator 118 stores the first snapshot graph (along with an identifier for the first time period) as part of the snapshot graphs 120 stored in the data store 108. In an example, the identifier for the first time period is a start date and time and an end date and time for the first time period.

Additionally or alternatively, some or all of the nodes within the user graph 114 may include timestamps. In an example, a node in the user graph 114 representing a document includes a timestamp that is indicative of creation of the document. The snapshot graph generator 118 may generate the first snapshot graph by selecting nodes in the user graph 114 that include timestamps that fall within the first time period. In an example, the user graph 114 includes a first node that includes a first timestamp and a second node that includes a second timestamp, where the first node and the second node are connected via an edge, and where the edge includes a third timestamp. The snapshot graph generator 118 includes the first node, the second node, and the edge in the first snapshot graph when the first timestamp, the second timestamp, and the third timestamp fall within the first time period.

Turning now to FIG. 3B, an example snapshot graph 300B that is generated from the user graph 300A using the processes described above is illustrated. The snapshot graph 300B includes the first node 302, the second node 304, the fourth node 312, the fifth node 316, the first edge 306, the third edge 314, and the fourth edge 318 due to the first edge 306, the third edge 314, and the fourth edge 318 having corresponding timestamps that fall within the one week period extending from Aug. 24, 2021 to Aug. 30, 2021. However, the snapshot graph 300B does not include the third node 308 or the second edge 310, as the second edge 310 has a corresponding timestamp that falls outside of the one week period extending from Aug. 24, 2021 to Aug. 30, 2021.

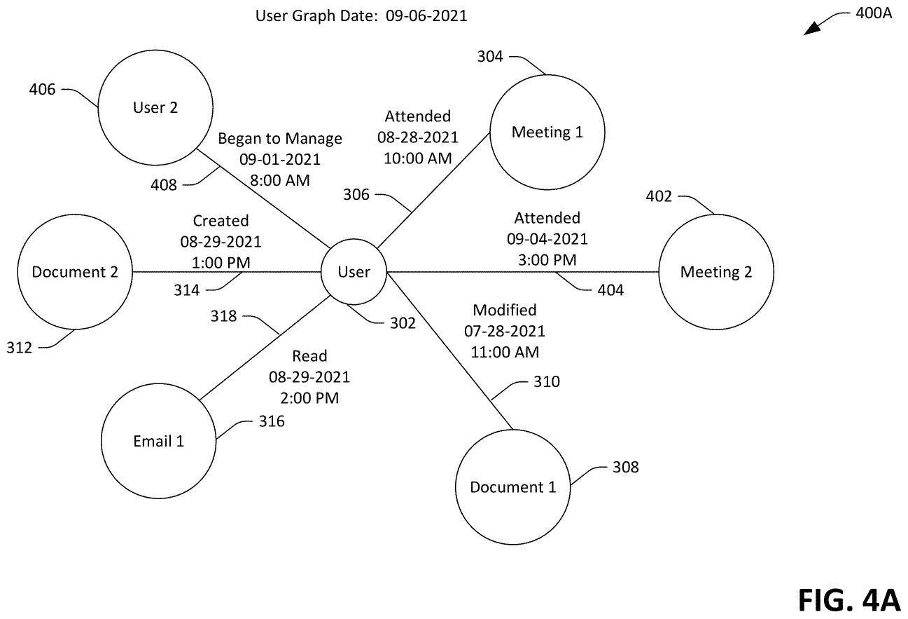

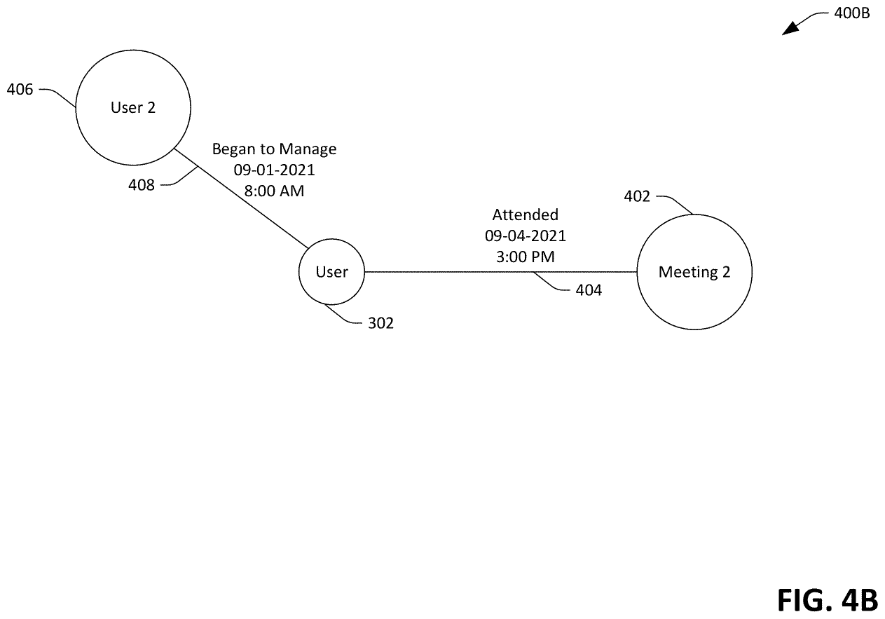

Referring now to FIG. 4A, an example user graph 400A of the user 112 at a second date (Aug. 6, 2021) is illustrated. In the example depicted in FIG. 4A, the user graph 400A includes nodes and edges that represent activities performed by the user 112 on and before Sep. 6, 2021. The user graph 400A may be or include the user graph 114 or the user graph 114 may be or include the user graph 400A. The user graph 400A includes the nodes 302, 304, 308, 312, 316 and the edges 306, 310, 314, 318 described above in the description of FIG. 3A. Additionally, the user graph 400A includes a sixth node 402 that represents a second meeting. The first node 302 is connected to the sixth node 402 via a fifth edge 404, where the fifth edge 404 includes a label indicating a relationship (attended) and a fifth timestamp (Sep. 4, 2021 3:00 PM) indicating that the user 112 attended the second meeting at the date and time indicated by the fifth timestamp. The user graph 400A also includes a seventh node 406 that represents a second user. The first node 302 is connected to the seventh node 406 via a sixth edge 408, where the sixth edge 408 includes a label indicating a relationship (began to manage) and a sixth timestamp (Sep. 1, 2021) indicating that the user 112 began to manage the second user at a date and time indicated by the sixth timestamp.

Referring back to FIG. 1, the snapshot graph generator 118 of the analytics application 116 selects a second subset of edges of the user graph 114, where the second subset of edges have corresponding timestamps that fall within a second time period that is different than the first time period. In an example, the second time period is a seven day period that immediately follows an end date of the first time period. The snapshot graph generator 118 generates a second snapshot graph (also referred to as a second subgraph) of the user graph 114 based upon the second subset of edges. The second snapshot graph includes a second subset of nodes of the user graph 114, where the second subset of nodes are connected via the second subset of edges. The second snapshot graph represents second activities performed by the user 112 in the plurality of applications during the second time period. Additionally or alternatively, the snapshot graph generator 118 may generate the second snapshot graph using timestamps included in nodes of the user graph 114 (described above). The snapshot graph generator 118 stores the second snapshot graph (along with an identifier for the second time period) as part of the snapshot graphs 120 stored in the data store 108.

Turning now to FIG. 4B, an example snapshot graph 400B that is generated from the user graph 400A is illustrated. The snapshot graph 400B includes the first node 302, the sixth node 402, and the seventh node 406 due to the fifth edge 404 and the sixth edge 408 having corresponding timestamps that fall within the one week period extending from Aug. 31, 2021 to Sep. 6, 2021.

The analytics application 116 identifies the first snapshot graph and the second snapshot graph from the snapshot graphs 120 stored in the data store 108 based upon a set of first timestamps and a set of second timestamps, respectively. The set of first timestamps and the set of second timestamps may be included within the user graph 114 (e.g., in nodes and edges of the user graph 114). Alternatively, the first snapshot graph and the second snapshot graph may each be labeled with the respective time periods that the first snapshot graph and the second snapshot graph represent, respectively. The analytics application 116 may identify the first snapshot graph and the second snapshot graph based upon labels assigned to the first snapshot graph and the second snapshot graph, where the labels are indicative of the respective time periods that the first snapshot graph and the second snapshot graph represent. The analytics application 116, via the ML engine 122, identifies one or more topics of interest (e.g., work areas) of the user 112 during each of the first time period and/or the second time period based upon nodes and edges of the first snapshot graph and nodes and edges of the second snapshot graph. In an example, the ML engine 122 identifies a first set of topics for the first time period based upon the first snapshot graph and a second set of topics for the second time period based upon the second snapshot graph. It is contemplated that the first set of topics and the second set of topics share some common topics; however, it is to be understood that the first set of topics and the second set of topics may or may not share common topics. It is also contemplated that the first set of topics and the second set of topics may be the same. The analytics application 116 stores the first set of topics for the first time period and the second set of topics for the second time period as part of the user analytics data 124.

According to embodiments, the ML engine 122 identifies a node in at least one of the first snapshot graph or the second snapshot graph based upon a number of incoming edges to the node. The ML engine 122 determines an entity that the node represents based upon metadata for the node and determines the topic of interest based upon an identifier for the entity included in the metadata.

According to embodiments, the analytics application 116 ranks the one or more topics of interest (for each of the first time period and the second time period) based upon suitable ranking criteria. In an example, the analytics application 116 ranks the one or more topics of interest based upon a number of nodes and/or edges associated with each identified topics. The analytics application 116 may select a threshold number of topics (e.g., top five, top ten, etc.) for the first time period and the second time period for further analysis (described below). In an example, the analytics application 116 selects five topics of interest from the first set of topics for the first time period and five topics of interest from the second set of topics for the second time period. The analytics application 116 stores the selected topics of interest as part of the user analytics data 124.

The analytics application 116, via the ML engine 122, identifies entities of interest associated with the one or more topics during different time periods based upon nodes and edges of the first snapshot graph and nodes and edges of the second snapshot graph. The entities of interest may include users, documents, emails, meetings, tasks, work areas, computer-executable applications, locations, and/or key phrases, where each of the entities are represented by a node in the first snapshot graph and/or the second snapshot graph. In an example, the ML engine 122 identifies first entities of interest associated with a topic during the first time period based upon the nodes and edges of the first snapshot graph and second entities of interest associated with the topic during the second time period based upon the nodes and the edges of the second snapshot graph. The first entities of interest and the second entities of interest may be the same entities or different entities. Furthermore, the first entities of interest and the second entities of interest may have some entities that are included in both groups. The analytics application 116 stores, as part of the user analytics data 124, identifiers for the first entities of interest associated with the topic during the first time period and identifiers for the second entities of interest associated with the topic during the second time period.

The analytics application 116 determines amounts of time that the user 112 has spent working on each of the one or more topics of interest during each of the first time period and the second time period based upon timestamps included in the first snapshot graph and the second snapshot graph, respectively. In an example, the first snapshot graph includes a first node representing the user 112, a second node representing a document, and a first edge connecting the first node to the second node. The first edge includes a label indicating a “modification” relationship, that is, the user 112 modified the document. The first edge also includes data that is indicative of a first duration of the modification of the document, that is, how long the user 112 spent modifying the document. In an example, the data includes a first timestamp corresponding to when the user 112 began to modify the document and a second timestamp corresponding to when the user 112 finished modifying the document. The analytics application 116 determines that the document is associated with one of the aforementioned topics of interest based upon nodes and edges of the first snapshot graph and/or nodes and edges of the second snapshot graph. The analytics application 116 computes the amount of time that the user spent modifying the document by taking a difference between the second timestamp and the first timestamp.

In another example, the first snapshot graph includes a third node representing a meeting the user 112 attended during the first time period. The first node representing the user 112 is connected to the third node via a second edge. The second edge includes a label indicating an “attended” relationship, that is, the user 112 attended the meeting. The second edge also includes data that is indicative of a second duration of meeting, that is, how long the user 112 spent in the meeting. In an example, the data includes a third timestamp corresponding to when the user 112 began to attend the meeting and a fourth timestamp corresponding to when the user 112 finished attending the meeting. The analytics application 116 determines that the meeting is associated with one of the aforementioned topics of interest based upon nodes and edges of the first snapshot graph and/or nodes and edges of the second snapshot graph. The analytics application 116 computes the amount of time that the user 112 spent attending the meeting by taking a difference between the fourth timestamp and the third timestamp. The analytics application 116 sums the first duration (corresponding to modifying the document) and the second duration (corresponding to attending the meeting) to determine an amount of time spent by the user 112 working on the topic during the first time period. The analytics application 116 may perform similar operations on other nodes/edges of the first snapshot graph in order to determine a total amount of time that the user 112 worked on the topic during the first time period (as well as total amounts of time that the user 112 worked on additional topics during the first time period). Furthermore, the analytics application 116 performs similar operations on nodes/edges of the second snapshot graph in order to determine a total amount of time that the user 112 worked on the topic during the second time period (as well as total amounts of time that the user 112 worked on additional topics during the second time period). The analytics application 116 stores, as part of the user analytics data 124, indications of the amounts of time that the user has spent working on the topic(s) of interest during each of the first time period and the second time period.

The analytics application 116 may also determine amounts of time that the user 112 has spent working on particular types of activities within each topic during each time period. Example types of activities include communicating with people, attending meetings, and drafting/modifying/reading documents, and/or drafting/reading emails. In an example, the first snapshot graph includes a fourth node that is connected to the first node representing the user 112 by a third edge, where the fourth node represents a second document that was modified by the user during the first time period. The second document is associated with the (same) topic that the document represented by the second node. The analytics application 116 determines that the second document is associated with the topic based upon the first snapshot graph and computes a duration of modification of the second document using processes similar to those described above. The analytics application 116 sums the duration of the modification of the document and the duration of the modification of the second document to determine an amount of time spent by the user 112 working on documents with respect to the topic during the first time period. The analytics application 116 stores, as part of the user analytics data 124, indications of the amounts of time that the user 112 has spent working on the particular types of activities within each topic during each time period.

The analytics application 116, via the ML engine 122, determines an amount of time that the user 112 is predicted to spend working on a topic during a future time period based upon the timestamps included in the first snapshot graph and the second snapshot graph, respectively. In an example, using the above-described processes, the analytics application 116 determines a first amount of time that the user 112 has spent on activities for a topic during a first time period and a second amount of time that the user 112 has spent on activities for the topic during a second time period. Using regression analysis, the ML engine 122 determines a third amount of time that the user 112 is predicted to spend working on the topic during a future time period (e.g., the next week) that occurs after the first time period and the second time period. In a specific example, the first time period, the second time period, and the future time period are sequential weeks, where the first time period is the previous week, the second time period is the week occurring before the previous week, and where the future time period is a week that is to occur immediately subsequent to the previous week. The ML engine 122 may also determines amounts of time that the user 112 is predicted to spend working on other topics in a similar manner.

The analytics application 116, via the ML engine 122, may also determine an amount of time that the user 112 is predicted to spend working on types of activities (e.g., drafting/modifying/reading documents, interacting with people, etc.) within the topic during the future time period using regression analysis. In an example, the ML engine 122 determines (1) a first amount of time corresponding to a first type of activity that is predicted to be performed by the user 112 with respect to the topic during the future time period and (2) a second amount of time corresponding to a second type of activity that is predicted to be performed by the user 112 with respect to the topic during the future time period. According to embodiments, the analytics application 116, via the ML engine 122, determines an amount of time that the user 112 is predicted to spend interacting with a second user with respect to the topic during the future time period using regression analysis. The analytics application 116 stores the above-discussed predictions as part of the user analytics data 124.

According to embodiments, the analytics application 116 generates a recommendation with respect to a topic based upon the predicted amount of time the user 112 is predicted to spend on the topic (or types of activities within the topic) during the future time period, where the recommendation indicates a suggested change in behavior of the user 112 during the future time period. The analytics application 116 may generate the recommendation based upon a role of the user 112 within an organization. In an example, the analytics application 116 identifies a second user represented by a node in the first snapshot graph and/or the second snapshot graph, where the second user has been identified by the analytics application 116 as being an entity associated with the topic. The analytics application 116 generates a recommendation that the user 112 delegate certain activities with respect to the topic to the second user. The analytics application 116 stores the recommendation as part of the user analytics data 124.

According to embodiments, the analytics application 116 determines a topic of interest to the user 112 during at least one the first time period or the second time period using the above-described processes, where the topic of interest is a work area of the user 112. The analytics application 116 also determines an amount of time that the user 112 is predicted to spend working in the work area during a future time period as described above. The analytics application 116 compares the amount of time to a threshold amount of time, where the threshold amount of time is based upon a role of the user 112 within an organization. When the amount of time exceeds the threshold amount of time, the analytics application 116 identifies a second user that is associated with the work area based upon nodes and edges of the first snapshot graph or the second snapshot graph. The analytics application 116 determines a role of the second user within the organization based upon metadata included in a node representing the second user in at least one of the first snapshot graph or the second snapshot graph. The analytics application 116 also determines a role of the user 112 within the organization based upon metadata included in a node representing the user 112 in at least one of the first snapshot graph or the second snapshot graph. The analytics application 116 generates a recommendation based upon the role of the user 112 within the organization and the role of the second user within the organization. In an example, the recommendation indicates that the user 112 delegate certain activities in the work area to the second user during the future time period. The analytics application 116, via the delivery component 128 causes the recommendation to be displayed to the user 112.

According to embodiments, the analytics application 116 causes some or all of the user analytics data 124 (determined via the ML engine 122) for a time period to be included in a snapshot graph corresponding to the time period. In an example, the ML engine 122 determines an amount of time spent by the user working on a topic during the first time period based upon the first snapshot graph. The analytics application 116 causes an indication of the first amount of time that the user 112 to be included in the first snapshot graph (e.g., by adding nodes/edges to the first snapshot graph and/or by modifying nodes and edges of the first snapshot graph). The ML engine 122 determines an amount of time spent by the user working on the topic during the second time period based upon the second snapshot graph. The analytics application 116 causes an indication of the second amount of time that the user 112 has worked on the topic during the second time period to be included in the second snapshot graph.

The visualization component 126 of the analytics application 116 generates a visualization based upon the first amount of time that the user 112 worked on a topic during the first time period and the second amount of time that the user 112 worked on the topic during the second time period, where the visualization includes a first visual indicator that is indicative of the first amount of time spent working on the topic during the first time period and a second visual indicator that is indicative of the second amount of time spent working on the topic during the second time period. The visualization may also include a third visual indicator that is indicative of the third amount of time that the user 112 is predicted to spend working on the topic during a future time period that occurs after the first time period and the second time period.

According to embodiments, the visualization is a plot having an x-axis that represents time periods (e.g., weeks, months, etc.) and ay-axis that represents amounts of time spent by the user 112. The plot includes a line that represents the topic, where a point on the line is indicative of an amount of time the user 112 spent working on the topic at a particular time in one of the time periods or a predicted amount of time that the user 112 is predicted to spend working on the topic during a future time period. The plot may also include additional lines corresponding to additional topics of interest of the user 112 (identified by the ML engine 122).

According to embodiments, the visualization is a radar chart that includes a plurality of spoke lines connected at a central point, where each spoke line is assigned to a different topic of interest to the user 112 during a time period (e.g., the past week). The central point represents zero. The radar chart includes a plot line that intersects each spoke line. A point of intersection of the plot line at a spoke line is indicative of an amount of effort spent by the user 112 on a topic during the time period.

The visualization component 126 may also generate a visualization that includes windows assigned to each of the topics identified by ML engine 122. A window assigned to a topic may include an identifier for the topic that is of interest to the user 112 during a time period, an amount time the user 112 spent working on the topic during the time period (or a predicted amount of time that the user 112 is predicted to spend working on the topic during a future time period), amounts of time the user 112 spent working on types of activities in the topic during the time period (or predicted amounts of time that the user 112 is predicted to spend working on types of activities in the topic during the time period), and/or identifiers for entities of interest in the topic during the time period.

The delivery component 128 transmits the user analytics data 124 described above (or a portion thereof) to the canvas application 140, whereupon the canvas application 140 presents the user analytics data 124 (or a portion thereof) to the user 112 within the canvas application GUI 148. In an example in which the analytics application 116 identifies a topic of interest to the user 112 during a first time period and a second time period and where the analytics application 116 determines an amount of time that the user 112 is predicted to spend working on the topic during a future time period, the canvas application 148 displays one or more of: an identifier for the topic that is of interest to the user 112, an identifier for the future time period and an indication of the amount of time that is predicted to be spent by the user 112 working on the topic during the future time period, an identifier for the first time period and an indication of the first amount of time that was spent by the user 112 on the topic during the first time period (or amounts of time spent by the user 112 on different types of activities with respect to the topic during the first time period), an identifier for the second time period and an indication of the second amount of time that was spent by the user 112 on the topic during the second time period (or amounts of time spent by the user 112 on different types of activities with respect to the topic during the second time period), recommendations for the user 112 for the future time period, identifiers for entities of interest associated with the topic during the first time period (along with the identifier for the first time period), and/or identifiers for entities of interest associated with the topic during the second time period (along with the identifier for the second time period). According to embodiments, the user analytics data 124 (or a portion thereof) is presented in a plot shown on the display 146.

In an example, delivery component 128 generates an email that includes the user analytics data 124 (or a portion thereof). In an example, the email includes an identifier for a topic of interest to the user 112 and an indication of an amount of time that the user 112 is predicted to spend working on the topic during a future time period. In an example, the future time period is an upcoming week. The delivery component 128 transmits the email to an email account of the user 112 and the email is presented to the user 112 on the display 146. The delivery component 128 may transmit a similar email (reflecting different user analytics data) to the email account of the user 112 at the beginning of each week. In another example, the delivery component 128 transmits the user analytics data 124 (or a portion thereof) to the canvas application 140 upon receiving a request from the canvas application 140. The canvas application 140 presents the user analytics data 124 (or a portion thereof) on the display 146 within the canvas application GUI 148.

According to embodiments, the analytics application 116 provides the user analytics data 124 to a search service (not shown in FIG. 1). The search service utilizes the user analytics data 124 in ranking search results obtained based upon search queries of the user 112. In an example, search service is a web search engine and the search results are web search results.

The graph application 110 may utilize the user analytics data 124 in order to surface more relevant search results when searching the user graph 114 based upon search queries. In an example, during the future time period described above, the graph application 110 receives a search query from the computing device 130. The graph application 110 executes a search over the user graph 114 based upon the search query. The graph application 110 obtains search results for the search. The graph application 110 ranks the search results based upon the user analytics data 124. In a specific example, the graph application 110 ranks the search results based upon a topic of interest (identified via the ML engine 122) and an amount of time that the user is predicted to spend working on the topic of interest during the future time period. For instance, if the user 112 is predicted to spend a relatively large amount of time working on the topic during the future time period, the graph application 110 prioritizes search results that are related to the topic. The graph application 110 causes a highest ranked search result in the search results to be presented on the display 146.

It is contemplated that the analytics application 116 generates new snapshot graphs at predefined intervals of time and that the analytics application 116 adds the new snapshot graphs to the snapshot graphs 120 in order for the new snapshot graphs to be utilized to generate new user analytics data. As noted above, the user graph 114 is modified over time to reflect the activities performed by the user 112 in the plurality of applications. In an example, subsequent to the future time period (now referred to as a third time period) elapsing, the snapshot graph generator 118 selects a subset of edges in the user graph 114 that have corresponding timestamps that fall within the third time period. The snapshot graph generator 118 generates a third snapshot graph based upon the subset of edges. The third snapshot graph includes a subset of nodes of the user graph 114 that are connected via the subset of edges. The third snapshot graph represents third activities performed by the user 112 in the plurality of applications during the third time period. The analytics application 116 stores the third snapshot graph and an identifier for the third time period in the data store 108 as part of the snapshot graphs 120.

It is to be understood that analytics application 116 may remove a snapshot graph from the data store 108 based upon an age of the snapshot graph. In an example where the analytics application 116 is configured to utilize a six month time frame for purposes of generating the user analytics data 124, the analytics application 116 removes snapshot graphs from the data store 108 that have dates that are older than six months from a current date.

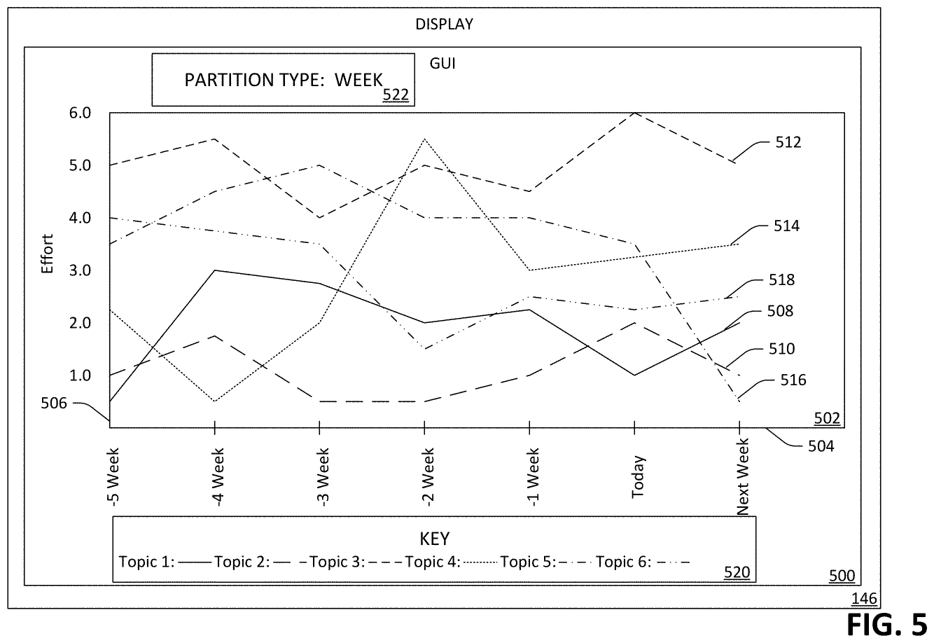

FIGS. 5, 6, and 7A-C illustrate different visualizations generated by the visualization component 126. Turning now to FIG. 5, an example GUI 500 that depicts a portion of the user analytics data 124 is illustrated. The canvas application 140 may present the GUI 500 on the display 146 of the computing device 130. As such, the GUI 500 may be or include the GUI 148 or the GUI 148 may be or include the GUI 500. The GUI 500 includes a plot 502 that illustrates user efforts in a plurality of topics over different time period, where the user efforts are identified by the analytics application 116 using the snapshot graphs 120 (described above). The plot 502 includes an x-axis 504 that represents time and a y-axis 506 that represents efforts of the user 112 (e.g., amounts of time spent by the user 112 working on the topics). In the example depicted in FIG. 5, the analytics application 116 has identified six topics of interest of the user 112. As such, the plot 502 includes a first line 508 assigned to a first topic, a second line 510 assigned to a second topic, a third line 512 assigned to a third topic, a fourth line 514 assigned to a fourth topic, a fifth line 516 assigned to a fifth topic, and a sixth line 518 assigned to a sixth topic. The GUI 500 includes a key 520 that indicates which lines correspond to which topics. The plot 502 includes indications of amounts of effort (e.g., amounts of time) spent by the user 112 working on the different topics during past time periods, as well as predicted amounts of time for a future time period (e.g., the next week). As depicted in FIG. 5, the user 112 is predicted to exert a relatively small amount of effort working on the fifth topic during the next week and a relatively large amount of effort working on the third topic during the next week. The GUI 500 also includes a partition type field 522. The partition type field 522 enables the user 112 to change the time periods reflected in the plot 502. In an example, the partition field 522 may be modified by the user 112 such that the x-axis 504 changes to monthly time periods instead of weekly time periods.

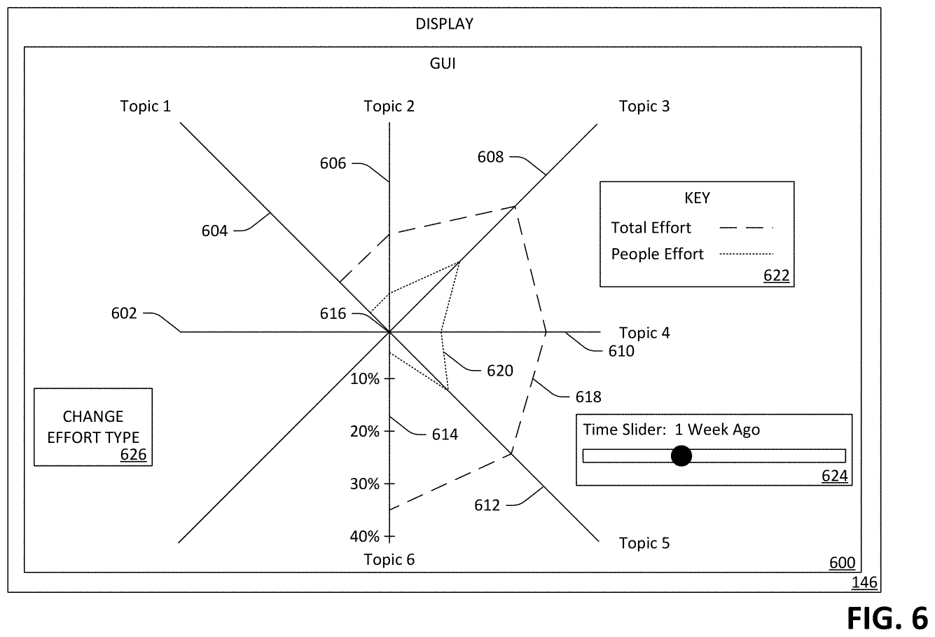

Turning now to FIG. 6, an example GUI 600 that depicts a portion of the user analytics data 124 is illustrated. The canvas application 140 may present the GUI 600 on the display 146 of the computing device 130. As such, the GUI 600 may be or include the GUI 148 or the GUI 148 may be or include the GUI 600. The GUI 600 includes a radar chart 602 (sometimes referred to as a spider chart) that illustrates efforts of the user 112 (e.g., amounts of time spent by the user 112 working on the topics) in a plurality of topics during a time period, where the efforts are identified by the analytics application 116 using the snapshot graphs 120 (described above). The radar chart 602 includes a first spoke line 604 assigned to a first topic, a second spoke line 606 assigned to a second topic, a third spoke line 608 assigned to a third topic, a fourth spoke line 610 assigned to a fourth topic, a fifth spoke line 612 assigned to a fifth topic, and a sixth spoke line 614 assigned to a sixth topic. Each of the spoke lines 604-614 are connected at a central point 616. A distance from the central point 616 to a point on one of the spoke lines 604-616 is indicative of an amount of effort (e.g., an amount of time) that the user 112 spent working on a topic represented by one of the spoke lines during a time period. The radar chart 602 includes a first plot line 618 that is indicative of total effort of the user 112 during a week prior to a current date. The radar chart 602 also includes a second plot line 620 that is indicative of communication efforts of the user 112 during the week prior to the current date. In an example, a first position of the first plot line 618 on the first spoke line 604 is indicative of a total amount of time that the user 112 spent working on the first topic during the week prior to the current date and a second position of the first plot line 618 on the second spoke line 606 is indicative of a total amount of time that the user 112 spent working on the second topic during the week prior to the current date. In another example, a first position of the second plot line 620 on the first spoke line 604 is indicative of an amount of time that the user 112 spent communicating with other people with respect to the first topic during the week prior to the current date and a second position of the second plot line 620 on the second spoke line 606 is indicative of an amount of time that the user 112 spent communicating with other people with respect to the second topic during the week prior to the current date. The GUI 600 includes a key 622 that indicates which plot lines correspond to which effort types. The GUI 600 includes a time slider 624 that enables the user 112 to select a different time period (e.g., two weeks ago) for which to display a radar chart. The GUI 600 includes a change effort type button 626 that enables the user 112 to change the effort type displayed in the radar chart 602. Example effort types include email effort, document effort, meeting effort, people effort, and commitment effort. In an example in which the user 112 selects document effort, the radar chart 602 is updated to display a third plot line (not shown in FIG. 6) that is indicative of efforts of the user 112 spent authoring, reading, creating documents during the week prior to the current date.

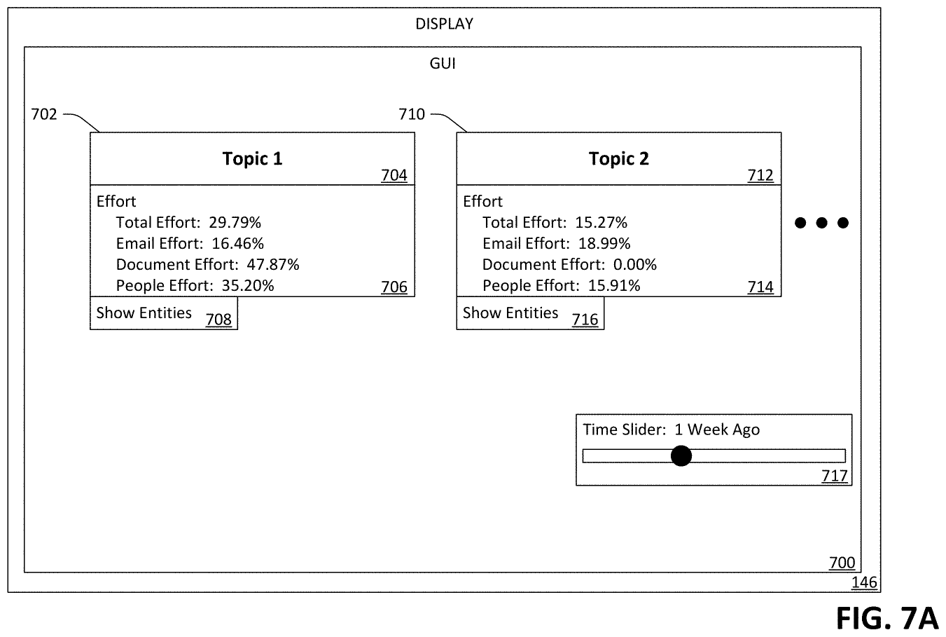

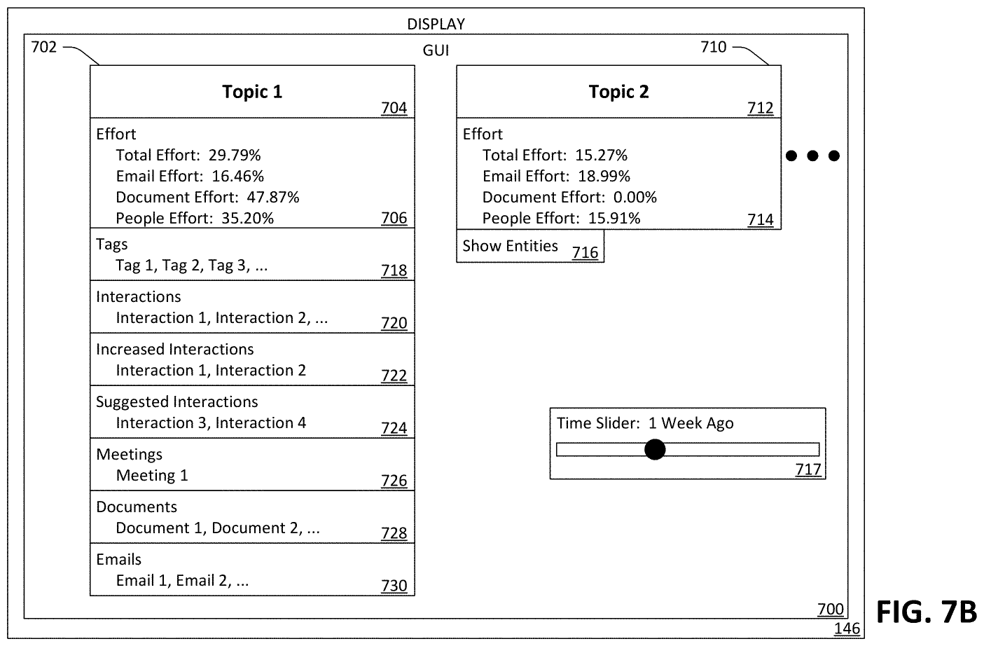

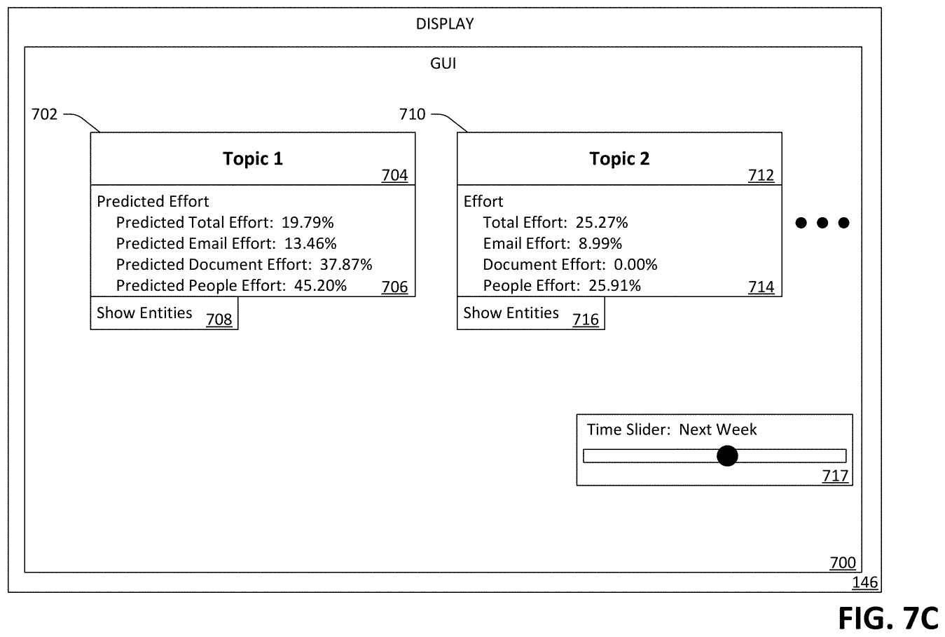

Turning now to FIG. 7A, an example GUI 700 that includes analytics of the user 112 is illustrated. The canvas application 140 may present the GUI 700 on the display 146 of the computing device 130. As such, the GUI 700 may be or include the GUI 148 or the GUI 148 may be or include the GUI 700. The GUI 700 includes a first window 702 assigned to a first topic (identified by the ML engine 122 using the snapshot graphs 120) during a time period. The first window 702 includes an identifier for the first topic 704. The first window 702 includes a first effort region 706 that displays efforts of the user 112 with respect to the first topic during the time period. In the example depicted in FIG. 7A, the efforts include a total amount of effort (an amount of time), as well as efforts (amounts of time) of the user 112 with respect to drafting emails, drafting documents, and communicating with people. Although not depicted in FIG. 7A, the efforts of the user 112 may also include meeting effort and commitment effort. The first window 702 includes a show entities button 708. When the show entities button 708 is selected by the user 112, the GUI 700 is updated to display identifiers for entities associated with the first topic that are identified via the ML engine 122 using the snapshot graphs 120. The GUI 700 further includes a second window 710 assigned to a second topic (identified by the ML engine 122 using the snapshot graphs 120) during the time period. The second window 710 includes an identifier for the second topic 712. The second window 710 includes a second effort region 714 that displays efforts of the user 112 with respect to the second topic during the time period. The second window 710 includes a show entities button 716. When the show entities button 716 is selected by the user 112, the GUI 700 is updated to display identifiers entities associated with the second topic that are identified via the ML engine 122 using the snapshot graphs 120. The GUI 700 further includes a time slider 717 that enables the user 112 to select a different time period (e.g., two weeks ago, next week, etc.) in which topics of interest of the user 112 are shown. Although not depicted in FIG. 7A, the GUI 700 may include additional windows assigned to additional topics identified via the ML engine 122 using the snapshot graphs 120, where the additional windows include similar visual features as the first window 702 and the second window 710.

Referring now to FIG. 7B, an updated view of the GUI 700 after selection of the show entities button 708 is illustrated. The GUI 700 depicted in FIG. 7B includes tags 718 (e.g., keywords or phrases) associated with the first topic during the time period, where the tags 718 are determined via the ML engine 122 using the snapshot graphs 120. The GUI 700 depicted in FIG. 7B includes identifiers for people 720 (e.g., users) that the user 112 interacted with during the time period with respect to the first topic (identified via the ML engine 122). The GUI 700 depicted in FIG. 7B includes identifiers for people 722 (e.g., users) that the user 112 had increased interaction with (identified via the ML engine 122) with respect to the first topic during the time period in comparison to time periods that occurred prior to the time period. The GUI 700 depicted in FIG. 7B includes identifiers for people 724 (e.g., users) that the ML engine 122 has identified that the user 112 should interact with during a future time period with respect to the first topic. The GUI 700 depicted in FIG. 7B includes identifiers for meetings 726 that the user 112 participated in during the time period (identified via the analytics application 116) with respect to the first topic. The GUI 700 depicted in FIG. 7B includes identifiers for documents 728 (identified via the analytics application 116) associated with user 112 and the first topic during the time period. The GUI 700 depicted in FIG. 7B includes identifiers for emails 730 (identified via the analytics application 116) associated with the user 112 and the first topic during the time period. Some or all of the identifiers depicted in FIG. 7B are selectable by the user 112. In an example, when the “Document 1” identifier is selected, the computing device 130 may access “Document 1” (e.g., from one of the plurality of user data sources 150-152) and present “Document 1” on the display 146.

Referring now to FIG. 7C, the time slider 717 has been adjusted to select the next week. The first effort region 706 of the first window 702 is updated to display predicted amounts of effort that the user 112 is predicted to spend working on the first topic during the next week (obtained via the ML engine 122). The second effort region 714 of the second window 710 is also updated to display predicted amounts of effort that the user 112 is predicted to spend working on the second topic during the next week (obtained via the ML engine 122).

According to embodiments, the GUI 500, the GUI 600, and the GUI 700 are presented concurrently with one another to the user 112 on the display 146 as part of a dashboard. In this manner, the user 112 is able to easily understand his/her efforts in different topics (e.g., work areas) during different time periods.

Although the analytics application 116 has been described as utilizing a first snapshot graph (representing first activities of the user 112 during a first time period) and a second snapshot graph (representing second activities of the user 112 during a second time period) in order to generate the user analytics data 124, it is to be understood that the analytics application 116 may utilize more than two snapshot graphs (each representing activities of the user during different time periods) in order to generate the user analytics data 124 for the user 112.

Although the analytics application 116 has been described above as determining amounts of time spent by the user 112 working on topic(s) of interest (or entities within the topic(s) of interest) during past time periods and predicting amounts of time that the user 112 is predicted to spend working on the topic(s) of interest (or the entities within the topic(s) of interest) during future time periods, other possibilities are contemplated. According to embodiments, the analytics application 116 determines amounts of efforts spent by the user 112 working on the topic(s) of interest (or entities within the topic(s) of interest) during the past time periods and predicts amounts of efforts that the user 112 is predicted to exert working on the topic(s) of interest (or the entities within the topic(s) of interest) during the future time periods. An amount of effort exerted in a topic of interest may be a function of an amount of time the user 112 spent working on the topic of interest and the types activities performed by the user 112 while the user 112 is working on the topic of interest. In an example, the user 112 spends a first amount of time performing a first type of activity with respect to a topic of interest during a time period and a second amount of time performing a second type of activity with respect to the topic of interest during the time period. In the example, the first type of activity is drafting emails with respect to the topic of interest and the second type of activity is attending meetings with respect to the topic of interest. Following the example, the analytics application 116 multiples the first amount of time by a first weight to generate a first amount of effort that the user 112 exerted with respect to the topic performing the first type of activity, where the first weight is assigned to the first type of activity. The analytics application 116 also multiples the second amount of time by a second weight to generate a second amount of effort that the user 112 exerted with respect to the topic performing the second type of activity, where the second weight is assigned to the second type of activity. The second weight may be greater than the first weight to reflect that attending meetings is more burdensome to the user 112 than drafting emails. As such, the second amount of effort may be greater than the first amount of effort, even though the first amount of time may be greater than the second amount of time. The analytics application 116 sums the first amount of effort and the second amount of effort to generate an overall amount of effort that the user 112 spent working on the topic of interest during the time period. The analytics application 116 may generate predictions based upon amounts of effort (as opposed to amounts of time) in a manner similar to that described above (e.g., using regression analysis).

Although the graph application 110 and the analytics application 116 are described above as both executing on the computing system 102, other possibilities are contemplated. According to embodiments, the graph application 110 and the analytics application 116 execute on separate computing systems. Furthermore, although the user graph 114 and the snapshot graphs 120 are described above as both being stored in the data store 108, other possibilities are contemplated. According to embodiments, the user graph 114 and the snapshot graphs 120 are stored in separate data stores. Although the analytics application 116 has been described above as being executed by the processor 104 of the computing system 102, other possibilities are contemplated. According to embodiments, some or all of the functionality of the analytics application 116 is executed by the processor 134 of the computing device 130.

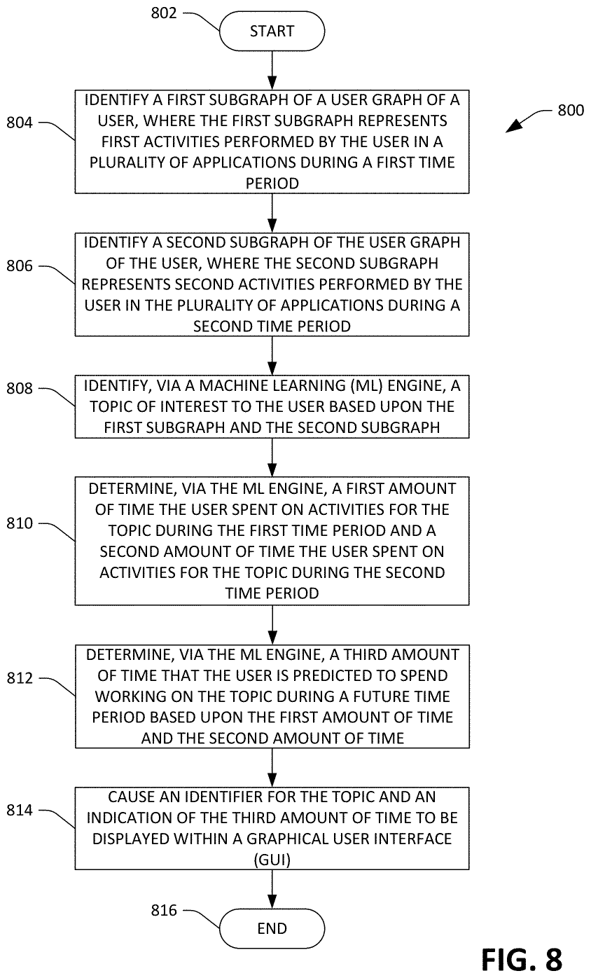

FIG. 8 illustrates an example methodology relating to over time analytics using graph intelligence. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodology can be stored in a computer-readable medium, displayed on a display device, and/or the like.

Referring now to FIG. 8, an example methodology 800 performed by a computing system that facilitates over time analytics using graph intelligence is illustrated. The methodology 800 begins at 802, and at 804 the computing system identifies a first subgraph of a user graph of a user based on a set of first timestamps within the user graph. The user graph includes nodes and edges connecting the nodes. The nodes and the edges represent activities performed by the user in a plurality of applications. The first subgraph represents first activities performed by the user in the plurality of applications during a first time period. At 806, the computing system identifies a second subgraph of the user graph based on a set of second timestamps within the user graph. The second subgraph represents second activities performed by the user in the plurality of applications during a second time period. At 808, the computing system identifies, via a ML engine, a topic of interest to the user based upon first data included in the first subgraph and second data included in the second subgraph. At 810, the computing system determines, via the ML engine, a first amount of time that the user spent on activities for the topic of interest during the first time period and a second amount of time the user spent on activities for the topic of interest during the second time period. At 812, the computing system determines, via the ML engine, a third amount of time that the user is predicted to spend working on the topic during a future time period based upon the first amount of time and the second amount of time the user spent on the topic. At 814, the computing system causes an identifier for the topic and an indication of the third amount of time to be displayed within a GUI to the user. The methodology 800 concludes at 816.

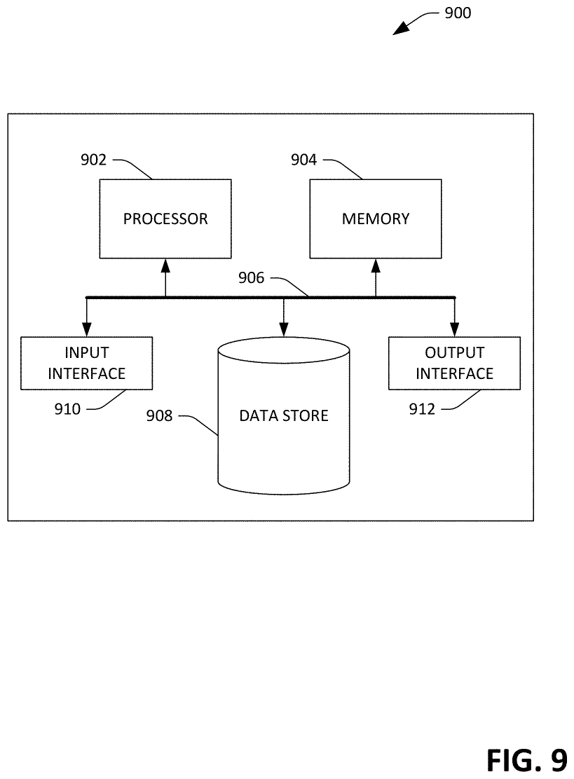

Referring now to FIG. 9, a high-level illustration of an example computing device 900 that can be used in accordance with the systems and methodologies disclosed herein is illustrated. For instance, the computing device 900 may be used in a system that computes over time analytics using graph intelligence. By way of another example, the computing device 900 can be used in a system that displays visualizations that are indicative of over time analytics. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store user graphs, snapshot graphs (subgraphs) of the user graphs, user analytics data, etc.

The computing device 900 additionally includes a data store 908 that is accessible by the processor 902 by way of the system bus 906. The data store 908 may include executable instructions, user graphs, snapshot graphs (subgraphs) of the user graphs, user analytics data, etc.

The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

The present disclosure relates to over time analytics using graph intelligence according to at least the following examples:

(A1) In one aspect, some embodiments include a method (e.g., 800) executed by a processor (e.g., 104) of a computing system (e.g., 102). The method includes identifying (e.g., 804) a first subgraph (e.g., 300B) of a user graph (e.g., 114) of a user (e.g., 112) based on a set of first timestamps within the user graph, where the user graph includes nodes and edges connecting the nodes, where the nodes and the edges represent activities performed by the user in a plurality of applications, and where the first subgraph represents first activities performed by the user in the plurality of applications during a first time period. The method further includes identifying (e.g., 806) a second subgraph (e.g., 400B) of the user graph based on a set of second timestamps within the user graph, where the second subgraph represents second activities performed by the user in the plurality of applications during a second time period. The method additionally includes identifying (e.g., 808), via a machine learning (ML) engine (e.g., 122), a topic of interest to the user based upon first data included in the first subgraph and second data included in the second subgraph. The method also includes determining (e.g., 810), via the ML engine, a first amount of time the user spent on activities for the topic of interest during the first time period and a second amount of time the user spent on activities for the topic of interest during the second time period. The method further includes determining (e.g., 812), via the ML engine, a third amount of time that the user is predicted to spend working on the topic during a future time period based upon the first amount of time and the second amount of time the user spent on the topic. The method additionally includes causing (e.g., 814) an identifier for the topic and an indication of the amount of time to be displayed within a graphical user interface (GUI) (e.g., 148) to the user.

(A2) In some embodiments of the method of A1, the method further includes identifying, via the ML engine, a second topic of interest to the user based upon the first data included in the first subgraph and the second data included in the second subgraph. The method additionally includes determining, via the ML engine, a fourth amount of time the user spent on activities for the second topic of interest during the first time period and a fifth amount of time the user spent on activities for the second topic of interest during the second time period. The method also includes determining, via the ML engine, a sixth amount of time that the user is predicted to spend working on the second topic during the future time period based upon the fourth amount of time and the fifth amount of time. The method further includes causing an identifier for the second topic and an indication of the sixth amount of time to be displayed within the GUI to the user concurrently with the identifier for the topic and the indication of the third amount of time.

(A3) In some embodiments of any of the methods of A1-A2, identifying the topic of interest to the user includes identifying a node in at least one of the first subgraph or the second subgraph based upon a number of incoming edges to the node and determining an entity that the node represents based upon metadata for the node, where the topic is identified based upon the determined entity.

(A4) In some embodiments of any of the methods of A1-A3, the method further includes generating a recommendation for the user based upon the third amount of time that the user is predicted to spend working on the topic during the future time period, where the recommendation indicates a suggested change in behavior of the user during the future time period. The method additionally includes causing the recommendation to be presented within the GUI to the user.

(A5) In some embodiments of any of the methods of A1-A4, the recommendation is additionally based upon a role of the user within an organization.

(B1) In another aspect, some embodiments include a computing system (e.g., 102) that includes a processor (e.g., 104) and memory (e.g., 106). The memory stores instructions that, when executed by the processor, cause the processor to perform any of the methods described herein (e.g., any of A1-A5).

(C1) In yet another aspect, some embodiments include a non-transitory computer-readable storage medium that includes instructions that, when executed by a processor (e.g., 104), cause the processor to perform any of the methods described herein (e.g., any of A1-A5).

(D1) In another aspect, some embodiments include a method executed by a computing system (e.g., 102) that includes a processor (e.g., 104) and memory (e.g., 106). The method includes identifying a first subgraph (e.g., 300B) of a user graph (e.g., 114) of a user (e.g., 112) based on a set of first timestamps within the user graph, where the user graph includes nodes and edges connecting the nodes, where the nodes and the edges represent activities performed by the user in a plurality of applications, and where the first subgraph represents first activities performed by the user in the plurality of applications during a first time period. The method further includes identifying a second subgraph (e.g., 400B) of the user graph based on a set of second timestamps within the user graph, where the second subgraph represents second activities performed by the user in the plurality of applications during a second time period. The method additionally includes identifying, via a machine learning (ML) engine (e.g., 122), a topic of interest to the user based upon first data included in the first subgraph and second data included in the second subgraph. The method also includes determining, via the ML engine, a first amount of time the user spent on activities for the topic of interest during the first time period and a second amount of time the user spent on activities for the topic of interest during the second time period. The method further includes determining, via the ML engine, a third amount of time that the user is predicted to spend working on the topic during a future time period based upon the first amount of time and the second amount of time the user spent on the topic. The method additionally includes causing an identifier for the topic and an indication of the third amount of time to be displayed to the user.

(D2) In some embodiments of the method of D1, the method further includes causing an indication of the first amount of time and an identifier for the first time period to be displayed to the user. The method additionally includes causing an indication of the second amount of time and an identifier for the second time period to be displayed to the user.

(D3) In some embodiments of the method of D2, the indication of the first amount of time, the identifier for the first time period, the indication of the second amount of time, the identifier for the second time period, the indication of the third amount of time, an identifier for the future time period, and the identifier for the topic are displayed in a plot presented on a display (e.g., 146).

(D4) In some embodiments of any of the methods of D1-D3, each edge in the user graph includes a timestamp. The method further includes prior to identifying the first subgraph, selecting a first subset of edges in the user graph that have corresponding timestamps falling within the first time period. The method additionally includes generating the first subgraph based upon the first subset of edges, where the first subgraph comprises a first subset of nodes in the nodes, where the first subset of nodes are connected via the first subset of edges. The method also includes prior to identifying the second subgraph, selecting a second subset of edges in the user graph that have corresponding timestamps falling within the second time period. The method further includes generating the second subgraph based upon the second subset of edges, where the second subgraph comprises a second subset of nodes in the nodes, where the second subset of nodes are connected via the second subset of edges.

(D5) In some embodiments of any of the methods of D1-D4, each node in the user graph represents an entity associated with the user or an activity of the user.

(D6) In some embodiments of any of the methods of D1-D5, the method further includes during the future time period, receiving a search query from a computing device (e.g., 130) operated by the user. The method additionally includes executing a search over the user graph based upon search query. The method also includes obtaining search results for the search. The method further includes ranking the search results based upon the topic of interest and the third amount of time that the user is predicted to spend working on the topic of interest during the future time period. The method additionally includes causing a highest ranked search result in the search results to be presented on a display of the computing device.

(D7) In some embodiments of any of the methods of D1-D6, the method further includes identifying, via the ML engine, entities associated with the topic of interest during the first time period based upon the first data comprised by the first subgraph. The method additionally includes causing identifiers for the entities to be displayed to the user.

(D8) In some embodiments of the method of D7, the entities include one or more of people, documents, emails, meetings, work areas, tasks, applications, locations, or key phrases.

(D9) In some embodiments of any of the methods of D1-D8, the third amount of time includes a fourth amount of time and a fifth amount of time, where the fourth amount of time corresponds to a first type of activity that is predicted to be performed by the user with respect to the topic during the future time period, where the fifth amount of time corresponds to a second type of activity that is predicted to be performed by the user with respect to the topic during the future time period.

(D10) In some embodiments of any of the methods of D1-D9, each edge in the user graph includes a timestamp. The method further includes subsequent to the future time period elapsing, selecting a subset of the edges in the user graph that have corresponding timestamps falling within the future time period. The method additionally includes generating a third subgraph based upon the subset of edges, where the third subgraph includes a subset of nodes of the user graph, where the subset of nodes are connected via the subset of edges, wherein the third subgraph represents third activities performed by the user in the plurality of applications during the future time period. The method also includes storing the third subgraph and an identifier for the future time period in a data store (e.g., 108)

(D11) In some embodiments of any of the methods of D1-D10, the plurality of applications include at least one of an email application, a real-time messaging application, a real-time meeting application, a word processing application, a spreadsheet application, a slideshow application, or a web browser.

(D12) In some embodiments of any of the methods of D1-D11, the topic of interest is a work area, an application, a location, or a person.

(E1) In another aspect, some embodiments include a computing system (e.g., 102) including a processor (e.g., 104) and memory (e.g., 106). The memory stores instructions that, when executed by the processor, cause the processor to perform any of the methods described herein (e.g., any of D1-D12).

(F1) In yet another aspect, some embodiments include a non-transitory computer-readable storage medium that includes instructions that, when executed by a processor (e.g., 104), cause the processor to perform any of the methods described herein (e.g., any of D1-D12).

(G1) In another aspect, some embodiments include a method performed by a computing system (e.g., 102) that includes a processor (e.g., 104). The method includes identifying a first subgraph (e.g., 300B) of a user graph (e.g., 114) of a user (e.g., 112) based on a set of first timestamps within the user graph, where the user graph includes nodes and edges connecting the nodes, where the nodes and the edges represent activities performed by the user in a plurality of applications, and where the first subgraph represents first activities performed by the user in the plurality of applications during a first time period. The method further includes identifying a second subgraph (e.g., 400B) of the user graph based on a set of second timestamps within the user graph, where the second subgraph represents second activities performed by the user in the plurality of applications during a second time period that immediately precedes the first time period. The method additionally includes identifying, via a machine learning (ML) engine (e.g., 122), a topic of interest to the user based upon first data included in the first subgraph and second data included in the second subgraph. The method also includes determining, via the ML engine, a first amount of time the user spent on activities for the topic of interest during the first time period and a second amount of time the user spent on activities for the topic of interest during the second time period. The method further includes determining, via the ML engine, a third amount of time that the user is predicted to spend working on the topic during a future time period based upon the first amount of time and the second amount of time the user spent on the topic. The method additionally includes causing an identifier for the topic and an indication of the third amount of time to be displayed to the user.

(G2) In some embodiments of the method of G1, the topic of interest to the user is a work area of the user. The method further includes comparing the third amount of time to a threshold amount of time, where the threshold amount of time is based upon a role of the user within an organization. The method additionally includes when the third amount of time exceeds the threshold amount of time: identifying a second user that is associated with the work area based upon at least one of the first data included in the first subgraph or the second data included in the second subgraph, determining a role of the second user within the organization based upon at least one of the first data included in the first subgraph or the second data included in the second subgraph, and causing a recommendation to be displayed to the user, where the recommendation indicates that the user delegate certain activities in the work area to the second user during the future time period, where the recommendation is based upon the role of the user within the organization and the role of the second user within the organization.

(G3) In some embodiments of any of the methods of G1-G2, causing the identifier for the topic and the indication of the third amount of time to be displayed to the user includes generating an email that includes the identifier for the topic and the indication of the third amount of time and transmitting the email to an email account of the user, where the email is presented on a display (e.g., 146) to the user.

(H1) In another aspect, some embodiments include a computing system (e.g., 102) including a processor (e.g., 104) and memory (e.g., 106). The memory stores instructions that, when executed by the processor, cause the processor to perform any of the methods described herein (e.g., any of G1-G3).

(I1) In yet another aspect, some embodiments include a non-transitory computer-readable storage medium that includes instructions that, when executed by a processor (e.g., 104), cause the processor to perform any of the methods described herein (e.g., any of G1-G3).

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. Such computer-readable storage media can include random-access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system, comprising:
a processor; and
memory storing instructions that, when executed by the processor, cause the processor to perform acts comprising:
identifying a first subgraph of a user graph of a user based on a set of first timestamps within the user graph,
wherein the user graph comprises nodes and edges connecting the nodes,
wherein the nodes and the edges represent activities performed by the user in a plurality of applications, and
wherein the first subgraph represents first activities performed by the user in the plurality of applications during a first time period;
identifying a second subgraph of the user graph based on a set of second timestamps within the user graph, wherein the second subgraph represents second activities performed by the user in the plurality of applications during a second time period;
identifying, via a machine learning (ML) engine, a topic of interest to the user based upon first data included in the first subgraph and second data included in the second subgraph;
determining, via the ML engine, a first amount of time the user spent on activities for the topic of interest during the first time period and a second amount of time the user spent on activities for the topic of interest during the second time period;
determining, via the ML engine, a third amount of time that the user is predicted to spend working on the topic during a future time period based upon the first amount of time and the second amount of time the user spent on the topic; and
causing an identifier for the topic and an indication of the third amount of time to be displayed to the user.

2. The computing system of claim 1, the acts further comprising:
causing an indication of the first amount of time and an identifier for the first time period to be displayed to the user; and
causing an indication of the second amount of time and an identifier for the second time period to be displayed to the user.

3. The computing system of claim 2, wherein the indication of the first amount of time, the identifier for the first time period, the indication of the second amount of time, the identifier for the second time period, the indication of the third amount of time, an identifier for the future time period, and the identifier for the topic are displayed in a plot presented on a display.

4. The computing system of claim 1, wherein each edge in the user graph comprises a timestamp, the acts further comprising:
prior to identifying the first subgraph, selecting a first subset of edges in the user graph that have corresponding timestamps falling within the first time period;
generating the first subgraph based upon the first subset of edges, wherein the first subgraph comprises a first subset of nodes in the nodes, wherein the first subset of nodes are connected via the first subset of edges;
prior to identifying the second subgraph, selecting a second subset of edges in the user graph that have corresponding timestamps falling within the second time period; and
generating the second subgraph based upon the second subset of edges, wherein the second subgraph comprises a second subset of nodes in the nodes, wherein the second subset of nodes are connected via the second subset of edges.

5. The computing system of claim 1, wherein each node in the user graph represents:
an entity associated with the user; or
an activity of the user.

6. The computing system of claim 1, the acts further comprising:
during the future time period, receiving a search query from a computing device operated by the user;
executing a search over the user graph based upon search query;
obtaining search results for the search;
ranking the search results based upon the topic of interest and the third amount of time that the user is predicted to spend working on the topic of interest during the future time period; and
causing a highest ranked search result in the search results to be presented on a display of the computing device.

7. The computing system of claim 1, the acts further comprising:
identifying, via the ML engine, entities associated with the topic of interest during the first time period based upon the first data comprised by the first subgraph; and
causing identifiers for the entities to be displayed to the user.

8. The computing system of claim 7, wherein the entities include one or more of:
people;
documents;
emails;
meetings;
work areas;
tasks;
applications;
locations; or
key phrases.

9. The computing system of claim 1, wherein the third amount of time comprises a fourth amount of time and a fifth amount of time, wherein the fourth amount of time corresponds to a first type of activity that is predicted to be performed by the user with respect to the topic during the future time period, wherein the fifth amount of time corresponds to a second type of activity that is predicted to be performed by the user with respect to the topic during the future time period.

10. The computing system of claim 1, wherein each edge in the user graph comprises a timestamp, the acts further comprising:
subsequent to the future time period elapsing, selecting a subset of the edges in the user graph that have corresponding timestamps falling within the future time period;
generating a third subgraph based upon the subset of edges, wherein the third subgraph comprises a subset of nodes of the user graph, wherein the subset of nodes are connected via the subset of edges, wherein the third subgraph represents third activities performed by the user in the plurality of applications during the future time period; and
storing the third subgraph and an identifier for the future time period in a data store.

11. The computing system of claim 1, wherein the plurality of applications include at least one of:
an email application;
a real-time messaging application;
a real-time meeting application;
a word processing application;
a spreadsheet application;
a slideshow application; or
a web browser.

12. The computing system of claim 1, wherein the topic of interest is a work area, an application, a location, or a person.

13. A method executed by a processor of a computing system, the method comprising:
identifying a first subgraph of a user graph of a user based on a set of first timestamps within the user graph,
wherein the user graph comprises nodes and edges connecting the nodes,
wherein the nodes and the edges represent activities performed by the user in a plurality of applications, and
wherein the first subgraph represents first activities performed by the user in the plurality of applications during a first time period;
identifying a second subgraph of the user graph based on a set of second timestamps within the user graph, wherein the second subgraph represents second activities performed by the user in the plurality of applications during a second time period;
identifying, via a machine learning (ML) engine, a topic of interest to the user based upon first data included in the first subgraph and second data included in the second subgraph;
determining, via the ML engine, a first amount of time the user spent on activities for the topic of interest during the first time period and a second amount of time the user spent on activities for the topic of interest during the second time period;
determining, via the ML engine, a third amount of time that the user is predicted to spend working on the topic during a future time period based upon the first amount of time and the second amount of time the user spent on the topic; and
causing an identifier for the topic and an indication of the amount of time to be displayed within a graphical user interface (GUI) to the user.

14. The method of claim 13, further comprising:
identifying, via the ML engine, a second topic of interest to the user based upon the first data included in the first subgraph and the second data included in the second subgraph;
determining, via the ML engine, a fourth amount of time the user spent on activities for the second topic of interest during the first time period and a fifth amount of time the user spent on activities for the second topic of interest during the second time period;
determining, via the ML engine, a sixth amount of time that the user is predicted to spend working on the second topic during the future time period based upon the fourth amount of time and the fifth amount of time; and
causing an identifier for the second topic and an indication of the sixth amount of time to be displayed within the GUI to the user concurrently with the identifier for the topic and the indication of the third amount of time.

15. The method of claim 13, wherein identifying the topic of interest to the user comprises:
identifying a node in at least one of the first subgraph or the second subgraph based upon a number of incoming edges to the node; and
determining an entity that the node represents based upon metadata for the node, wherein the topic is identified based upon the determined entity.

16. The method of claim 13, further comprising:
generating a recommendation for the user based upon the third amount of time that the user is predicted to spend working on the topic during the future time period, wherein the recommendation indicates a suggested change in behavior of the user during the future time period; and
causing the recommendation to be presented within the GUI to the user.

17. The method of claim 16, wherein the recommendation is additionally based upon a role of the user within an organization.

18. A non-transitory computer-readable storage medium comprising instructions that, when executed by a processor, cause the processor to perform acts comprising:
identifying a first subgraph of a user graph of a user based on a set of first timestamps within the user graph,
wherein the user graph comprises nodes and edges connecting the nodes,
wherein the nodes and the edges represent activities performed by the user in a plurality of applications, and
wherein the first subgraph represents first activities performed by the user in the plurality of applications during a first time period;
identifying a second subgraph of the user graph based on a set of second timestamps within the user graph, wherein the second subgraph represents second activities performed by the user in the plurality of applications during a second time period that immediately precedes the first time period;
identifying, via a machine learning (ML) engine, a topic of interest to the user based upon first data included in the first subgraph and second data included in the second subgraph;
determining, via the ML engine, a first amount of time the user spent on activities for the topic of interest during the first time period and a second amount of time the user spent on activities for the topic of interest during the second time period;
determining, via the ML engine, a third amount of time that the user is predicted to spend working on the topic during a future time period based upon the first amount of time and the second amount of time the user spent on the topic; and
causing an identifier for the topic and an indication of the third amount of time to be displayed to the user.

19. The non-transitory computer-readable storage medium of claim 18, wherein the topic of interest to the user is a work area of the user, the acts further comprising:
comparing the third amount of time to a threshold amount of time, wherein the threshold amount of time is based upon a role of the user within an organization; and
when the third amount of time exceeds the threshold amount of time:
identifying a second user that is associated with the work area based upon at least one of the first data included in the first subgraph or the second data included in the second subgraph;
determining a role of the second user within the organization based upon at least one of the first data included in the first subgraph or the second data included in the second subgraph; and
causing a recommendation to be displayed to the user, wherein the recommendation indicates that the user delegate certain activities in the work area to the second user during the future time period, wherein the recommendation is based upon the role of the user within the organization and the role of the second user within the organization.

20. The non-transitory computer-readable storage medium of claim 18, wherein causing the identifier for the topic and the indication of the third amount of time to be displayed to the user comprises:
generating an email that includes the identifier for the topic and the indication of the third amount of time; and
transmitting the email to an email account of the user, wherein the email is presented on a display to the user.
